(19) United States
(12) Patent Application Publication
(10) Pub. No.: US 2026/0268322 A1
(43) Pub. Date: Sep. 10, 2026

(54) SYSTEMS AND METHODS FOR NETWORK GENERATION OF NORMALIZED AND VALIDATED USER INFORMATION AND STAND-IN

(71) Applicant: MASTERCARD INTERNATIONAL INCORPORATED, Purchase, NY (US)

(72) Inventors: Kyle Williams, Wentzville, MO (US); Amit Anand, Kirkland, WA (US); Kristóf Gyimesi, Dabas (HU); Noelle Seawright, Atlanta, GA (US); Péter Andi, Budapest (HU)

(21) Appl. No.: 19/075,242

(22) Filed: Mar. 10, 2025

(51) Int. Cl. G06Q 20/40; H04L 67/306

(52) U.S. Cl. CPC G06Q 20/401; H04L 67/306

(57) ABSTRACT

Normalization and validation systems and methods are described herein for generating normalized and validated user data from unnormalized data. The systems and methods include: receiving a request message including (i) an indicator requesting validation of user data of a cardholder initiating a transaction, and (ii) the user data in a plurality of data elements of the request message; receiving a response message that includes a validity indicator; storing valid data elements as validated user data; analyzing validated user data to determine unnormalized characters present within a character string of the validated user data; normalizing the unnormalized characters by performing normalization steps on the character string to generate normalized characters; generating normalized user data; and transmitting to a sender of the request message an enhanced response message that includes the normalized user data located adjacent to the user data, thereby providing the normalized user data to the sender.

### BACKGROUND OF THE DISCLOSURE

The field of the disclosure relates generally to normalizing user information and generating a database of validated user information, and, more particularly, to network-based stand-in systems and methods for generating normalized and validated data for storage within a database and subsequent processing.

In today's computer-driven world, e-commerce transactions and payments via credit cards and other forms of digital payment have experienced rapid growth, make up a large percentage of total sales, and will continue to grow and be a large percentage of total sales. Companies in the payment processing field spend significant time and resources collecting and protecting sensitive user information such as personal identifiable information (PII), ensuring the validity of transactions, and preventing fraud. One major aspect of being able to confirm the validity of a transactions is to ensure that a user is who they say they are, for example by way of confirming a user's name and/or address (e.g., that a payment device or card being used by the user is associated with a proper address of the user for billing purposes). In the past, printed phonebooks represented a somewhat reliable means to obtain and verify (e.g., validate) name and/or address information of individuals, but even phonebooks had their own set of limitations and inaccuracies. For example, phonebooks typically published name and address information that the telephone service provider received upon a user's initial ordering of a landline at a particular residence. The information in the phonebook easily became outdated if the user moved to a new residence while keeping the same landline number or did not continue landline service at the new residence.

Address information may be obtained (e.g., scraped, purchased, etc.) from sources such as government records (e.g., census data, voter rolls, other registry data) and entities such as utility companies, health care providers, and/or other data partners or vendors such as “data brokers.” Additionally, companies in the payment processing industry, including merchants, payment card issuers, banks, and/or processors may obtain their own collection of user information over the course of conducting transactions (e.g., when a user is required to provide an address when signing up for a credit card or opening a bank account). However, regardless of the source, very little, if any of this user information, is normalized for efficient downstream/subsequent usage, and can also suffer from unreliability, inconsistency, inaccuracy, and other flaws.

For example, the style and/or format in which address information is presented varies greatly from territory to territory. Even if there are similarities in the structure of address information from various countries such as the United States, Canada, Ireland, Netherlands, and Singapore, intaking address information from so many different sources oftentimes creates inconsistent data that is expensive and difficult to use in an effective manner. For example, many countries do not have a singular address authority such as the U.S. Postal Service in the United States and the Royal Mail in the United Kingdom, where effectively every single address in the entire country has been mapped out and is known. In particular, developing countries may have no trusted source for accurate address information.

To date, acquiring address information from various territories has largely been a self-guided endeavor, where the entity collecting or otherwise acquiring such address information must perform its own authentication of the information for the generation of accurate user information (e.g., name and address information). As discussed above, sourcing accurate name and address data (e.g., from data brokers) is expensive and challenging to obtain, and there are many providers who have some user information (e.g., name), but not all user information (e.g., name and address). There is not a single authoritative source of information that is made available publicly. As such, significant time and resources are spent aggregating and cleansing (e.g., third party) data in order to perform certain services such as approving transactions based on accurate name and address information.

Within the payment processing technical field, there exists an optional service that merchants may use if they would like for the card issuer to validate a billing address that a cardholder has provided. For example, a merchant may have the option to alert the issuer to validate that the billing address provided by the cardholder matches the billing address stored with the issuer bank that issued the cardholder's payment card (e.g., for the credit card used for a purchase). A determination is made by the issuer if the information (e.g., postal code, street address) matches, and such determination is passed through the payment processing network in a financial transaction interchange message (e.g., an ISO 8583 message or an ISO 20022 message). However, because this service is optional, it is not included in every request, and it requires the issuer to assume the role of being an authoritative data source.

Additionally, address verification (e.g., for mailing and billing address, as well as corresponding postal code(s)) are key factors in growing credit card approval rates through issuer decisioning and fraud prevention. This requires the merchant/acquirer to pass the address and postal code through an authorization message to the issuer to validate the information (e.g., by confirming that the information is a match to the information already on file for that particular individual/cardholder). When an issuer's system is unable to respond to an authorization request that includes this information that requires verification, another party such as a network operator (e.g., card network operator) may have to “stand-in” as a substitute for the issuer to approve or decline the transaction. However, in these situations, the network operator may not have the necessary information to be able to validate the accuracy of the address information. Transactions without an address validation are known to have significantly lower approval rates and significantly higher fraud rates.

Yet further, various match signals (like email-to-name, address-to-name, etc.) are generated and provided during the transaction process. For example, generated match signals are exposed to various products (e.g., global identity review products). To generate match signals, it is necessary to gather names from customer queries and an authoritative datastore (such as provider data). The names received from data partners and/or customer queries are frequently not in the correct format, or have other inconsistencies, which increases the difficulty of performing name matching and generating match signals.

In view of at least these problems discussed above, what is needed is a system for sourcing accurate, authoritative name and address information in an inexpensive and easily retrievable manner, via a single source, and to be able to leverage this information within and/or outside of traditional processing networks. These needs extend to both the names and addresses of individuals as well as businesses. Such accurate, authoritative name and address information would have a variety of beneficial uses in authenticating and authorizing payment transactions.

### BRIEF DESCRIPTION OF THE DISCLOSURE

In one embodiment, a computer system for generating normalized and validated user data from unnormalized data. The computer system including a normalization and validation computing device including at least one processor and a memory device in communication with the at least one processor, the at least one processor configured to: receive a request message including (i) an indicator requesting validation of user data of a cardholder initiating a transaction, and (ii) the user data in a plurality of data elements of the request message; receive a response message in response to the request message, wherein the response message includes a validity indicator associated with the plurality of data elements, the validity indicator configured to indicate whether one or more data elements of the plurality of data elements is valid; store the one or more valid data elements as validated user data in a validated user database; analyze the validated user data to determine unnormalized characters present within at least one character string of the validated user data; normalize the unnormalized characters by performing at least one of a plurality of normalization steps on the at least one character string to generate normalized characters; generate normalized user data based on the normalized characters; and transmit to a sender of the request message an enhanced response message that includes the normalized user data located adjacent to the user data that was received via the request message, thereby providing the normalized user data to the sender.

In another embodiment, a computer-implemented method for generating normalized and validated user data from unnormalized data, the method implemented by a computer system including one or more processors in communication with one or more memories, the method including: receiving a request message including (i) an indicator requesting validation of user data of a cardholder initiating a transaction, and (ii) the user data in a plurality of data elements of the request message; receiving a response message in response to the request message, wherein the response message includes a validity indicator associated with the plurality of data elements, the validity indicator configured to indicate whether one or more data elements of the plurality of data elements is valid; storing the one or more valid data elements as validated user data in a validated user database; analyzing the validated user data to determine unnormalized characters present within at least one character string of the validated user data; normalizing the unnormalized characters by performing at least one of a plurality of normalization steps on the at least one character string to generate normalized characters; generating normalized user data based on the normalized characters; and transmitting to a sender of the request message an enhanced response message that includes the normalized user data located adjacent to the user data that was received via the request message, thereby providing the normalized user data to the sender.

In yet another embodiment, one or more non-transitory computer-readable storage media with instructions stored thereon that, in response to being executed, cause a computer system for generating normalized and validated user data from unnormalized data to: receive a request message including (i) an indicator requesting validation of user data of a cardholder initiating a transaction, and (ii) the user data in a plurality of data elements of the request message; receive a response message in response to the request message, wherein the response message includes a validity indicator associated with the plurality of data elements, the validity indicator configured to indicate whether one or more data elements of the plurality of data elements is valid; store the one or more valid data elements as validated user data in a validated user database; analyze the validated user data to determine unnormalized characters present within at least one character string of the validated user data; normalize the unnormalized characters by performing at least one of a plurality of normalization steps on the at least one character string to generate normalized characters; generate normalized user data based on the normalized characters; and transmit to a sender of the request message an enhanced response message that includes the normalized user data located adjacent to the user data that was received via the request message, thereby providing the normalized user data to the sender.

### BRIEF DESCRIPTION OF THE DRAWINGS

FIGS. 1-5 show example embodiments of the systems and methods described herein.

FIG. 1 is a schematic diagram illustrating an example multi-party payment processing system for enabling payment transactions used in conjunction with network generation of normalized and validated user information in accordance with one embodiment of the present disclosure.

FIG. 2A is a block diagram of an example embodiment of a sub-system within the multi-party payment processing system that utilizes the normalization and validation (N&V) computing system shown in FIG. 1.

FIG. 2B is a block diagram of an alternative example embodiment of a sub-system within the multi-party payment processing system that utilizes the N&V computing system shown in FIG. 1.

FIG. 2C is a block diagram of an example embodiment of an operation for logging name and address information via the N&V computing system according to the present disclosure.

FIG. 2D is a block diagram of an example embodiment of a stand-in operation using information from the N&V computing system according to the present disclosure.

FIG. 2E is a process flow diagram showing an example method for processing a transaction using the N&V computing system according to the present disclosure.

FIG. 3A is a table listing example embodiments of normalization steps performed by the N&V computing system according to the present disclosure.

FIG. 3B is a table listing example embodiments of name, address, and validity information associated with the N&V computing system according to the present disclosure.

FIG. 3C is a process flow diagram showing an example method for normalizing user (name and address) information using the N&V computing system according to the present disclosure.

FIG. 3D illustrates an example embodiment of a computer message associated with the N&V computing system according to the present disclosure.

FIG. 4 is a diagram of components of one or more example client computing devices that may be used in the payment processing platform shown in FIGS. 2A and 2B.

FIG. 5 is a diagram of components of one or more example server devices that may be used in the payment processing platform shown in FIGS. 2A and 2B.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The following detailed description illustrates embodiments of the present disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for providing consumers with individualized user interfaces when purchasing goods and/or services (collectively referred to as “items”).

Payment processing systems (e.g., platform(s)) involve a plurality of parties, including a user/cardholder (e.g., purchaser), a merchant, a merchant bank, a network operator (e.g., card network operator) and an associated processing network (which may include a payment processor entity)), an issuer, and/or an issuer processor. Authentication of purchaser information such as the purchaser's address already occurs within a payment processing platform, but such authentication would be more potent and valuable if one of the entities within the payment processing platform would be the authoritative data source, where name and address information is stored in a format that is highly reliable and verified as being accurate.

In this regard, within a payment processing platform, a processing network operator is uniquely situated and well-suited for generating, managing, and providing an authoritative database of user information for use in connection with transactions made within the payment platform, and possible external uses. For example, processing network operators already have existing records and other data that can be leveraged to provide proof of a match (e.g., name and address information of a new transaction matches name and address information already on file). The superior positioning of a processing network operator within the system architecture for such tasks is even more apparent when comparing a processing network operator to other entities within the payment platform. For example, merchants tend to be more focused on selling goods than the tasks associated with authenticating and authorizing a cardholder for a purchase. And an issuer may be more prone to having outages (e.g., from cyber-attacks) than other entities within the payment platform.

Additional aspects of how the processing network operator is a preferred choice amongst the various payment platform entities to be the entity that generates, maintains, and provides an authoritative database of normalized and verified name and address information are described below. Take for example, a scenario where a user signs up for a new payment card, and the user provides their name and address information as part of the payment card application process. If the user is approved for the payment card, the physical payment card is mailed to the user's provided address by the processing network operator, and the user must then activate (e.g., by phone, QR code, etc.) the payment card to be able to begin using the payment card. The fact that the user activates the payment card after having received it at the physical address they provided serves as a form of self-authentication that the address truly is the address of the user. This address would be able to be marked as “verified” or “valid” within the authoritative database and used as a reference point for future transactions.

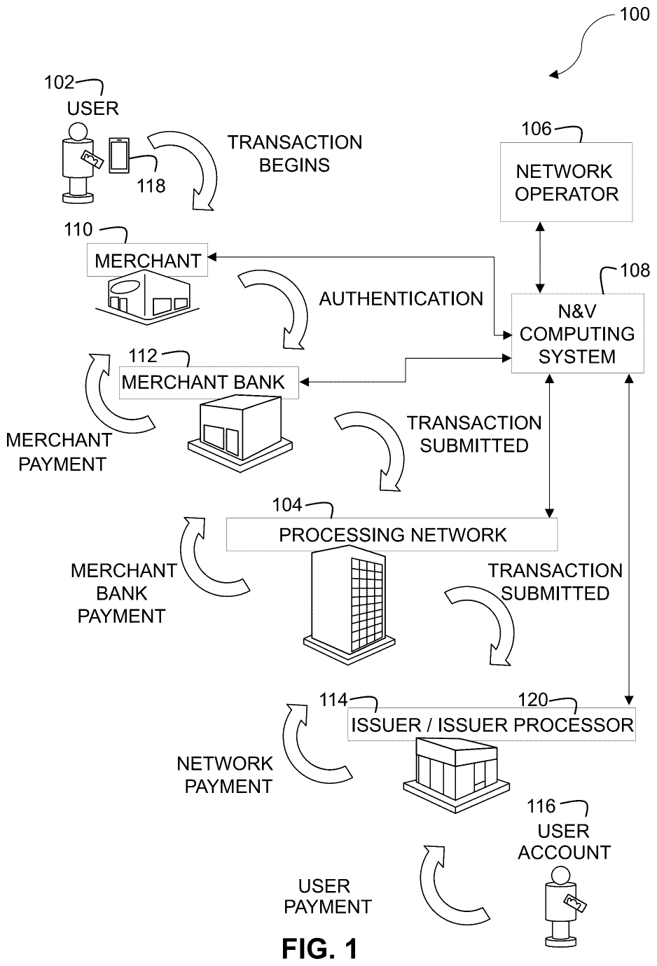

Another example is when a purchaser pays for gasoline at a fuel pump via a payment card and is asked to enter the postal code (e.g., zip code) associated with the billing address of the payment card before the transaction is approved. The postal code entered by the purchaser is transmitted to and/or stored by the applicable entities of a payment platform (e.g., as shown in FIG. 1). If it is determined that the postal code entered at the fuel pump matches the postal code in the billing address information stored by the processing network operator (or an associated payment processor), this data point would serve as another means to authenticate that particular piece of information (e.g., the matching of the entered postal code at the pump terminal to the postal code on file verifies the authenticity and accuracy of that purchaser's address).

In another example, for an online purchase, a purchaser may be required to enter their shipping address into the merchant's website, and the merchant captures that address and embeds it an electronic transaction message to the applicable entities in the payment platform for validation. If the applicable entities of the payment platform confirm(s) that the address provided to the merchant matches that which is on file with the applicable entities of the payment platform, then the transaction is allowed to proceed. However, during the processing of a transaction, even if an issuer, for example, indicates to the merchant that the transaction is suspicious (e.g., a certain piece of information does not match existing records), the merchant is able to make their own determination as to whether to approve or decline the transaction. A merchant could still approve a transaction that has been flagged if they are willing to take on the additional risk should there be an issue with the transaction.

While processing network operators already possess cardholder (e.g., user) name and address information, such name and address information would be even more powerful, usable, and useful if it were better normalized to account for the different formats and styles that are common when dealing with name and address information from numerous geographical regions. A high-level overview of an example of normalization of address data is as follows (more detailed examples are provided herein). Apartment numbers may include dashes, floors, unit numbers, etc., which may all be listed in one text line. Normalization in this case would include, for example, removing the dashes, converting floor and/or unit numbers/letters, and better aligning the data. More generally, normalization would include aspects such as splitting up street numbers, handling abbreviations (e.g., “Ct.”/“Court”, “St.”/“Street”), and all other nuances and iterations common to the listing of addresses. The normalized information thus provides a level of sophistication not currently present in such data, and allows for improved verifications and authentications within the payment platform, for example when it comes to matching data such as the abbreviation “St.” versus “Street” in an address field. By adding a layer of sophistication and refinement to this varied data through normalization, a computer system that may normally determine that “St.” is not a match for “Street” (e.g., because the computer system is rigidly coded) would be able to account for all sorts of nuances present in address data (e.g., in the process of determining a match).

Beyond the examples above, there is additional nuance that must be accounted for. Take for example, a street name such as “GRAYOAKS” (one word). In a hypothetical transaction message, the street name was transmitted as two words (“GREY OAKS”). Because the authoritative database would contain the proper format (spacing and spelling) of “GRAYOAKS,” it would be possible to detect and correct the improper spelling and spacing of “GREY OAKS.” Similar techniques are applicable to misspelled words, including, for example, nuanced spellings such as American versus English spellings for words such as “color”/“colour”, “defense”/“defence” and the like, and words meaning the same thing but unique to certain territories (e.g., “APT” for “apartment” in the United States compared to “FLT” for “flat” in the United Kingdom).

In operation, a merchant may send a request to validate a purchaser's address information as part of a transaction. This address would be checked against an authoritative source (e.g., normalized/validated information of an authoritative database) to determine if a match is found (e.g., to determine if the address matches the address that is on file). The response to the merchant would mirror the responses that the merchant would expect to normally receive from the issuer, so that this aspect of the transaction process remains consistent for the merchant. An appropriate reason code is provided to the merchant in the response. Moreover, a “match” may not be required to be a 100% match. For example, after the information is compared, an amount of matching may be determined, and gaps in the information may be filled in with fuzzy logic. Using fuzzy logic may assist in scenarios where an address such as “123 Grayoaks St.” is stored in the authoritative database, but the current transaction is asking for validation of “123 Grey Oaks St.” street (e.g., the “Grey” in the requested address does not match the “Gray” in the authoritative source, and there is a space between “Grey” and “Oaks”). The fuzzy logic performs fuzzy matching to make a determination that “Grey Oaks” is the same as “Grayoaks” despite the different spellings of “Grey” “Gray” and the space present between “Grey” and “Oaks.”

For example, in such a scenario, other look-up tools may be used to assist in the determination process. A search can be run to determine if “123 Grey Oaks St.” is an address that even exists. If the search determines that “123 Grey Oaks St.” does not even exist, this lends additional support to the determination that the listing of “Grey Oaks” was more likely than not supposed to be “Grayoaks” (e.g., since “Grey Oaks” is not an actual address). The validation process may take data in a piece by piece manner for analysis. For example, the validation process may look at the postal code first to determine if the postal code is a real postal code. When the analysis gets to the street name and number, the validation process may determine, for example, that “123 Grayoaks Street” does exist within the validated postal code. When each of the postal code and street number and name are determined as being valid, this will return a “true” value. Additionally, thresholds may be used to assign a matching and/or confidence level to the results. For example, if after comparing two addresses a match of greater than or equal to 80% match is determined to exist, the transaction may be green lit to proceed (e.g., even though a 100% match was not determined to exist). Address data may be split into components that are assigned a certain weight (e.g., 20% for street number, 20% for street name, 20% for postal code, 20% for city, 20% for state). While the above scenario focuses on address information, similar techniques would apply to name information as well.

In each of the above examples of purchase transactions, ISO 8583 messages may be used as the means for transmitting information such as the purchaser information and for the various requests and responses from the parties within the payment platform. ISO 8583 messages include (i) a message type indicator (MTI), indicating the type of transaction (e.g., authorization request, financial advice, reversal), (ii) data elements (e.g., “DE” or “DE's”) that contain actual data such as name and address information (e.g., an ISO 8583 message may include 192 DE's) of a cardholder (e.g., user data, also referred to as cardholder data), and (iii) bitmaps, indicating which data elements are present in the message. Data elements are the individual fields carrying the transaction information, where each data element has a specified meaning and format (although some data elements may be used as general purpose data elements). Country- and/or system-specific data elements can vary greatly from one another both in use and in form. Each data element is described in a standard format which defines the permitted content of any particular data element field (e.g., the type of characters permitted such as numeric, binary, etc.) and the field length (which may be fixed or variable). Examples of DE's include primary account number (PAN), card expiry date, payment amount, transaction date and time, conversion rate, and message authentication code (relevant for password or PIN entry). ISO 8583 messages may be more generally referred to as computer messages and/or (electronic) transaction messages. Additionally, or alternatively, ISO 20022 messages may be utilized in the same or similar manner as ISO 8583 messages as described herein.

More specifically, the normalization techniques of the present disclosure focus on reason codes and values (e.g., A, N, R, S, U, W, X, Y, Z) of certain data elements of an ISO 8583 message in connection with normalization. The “A” value represents the primary account number (PAN), which is typically the purchaser's card number. The “N” value represents numeric data, such as amounts or transaction codes. The “R” value represents alphanumeric data, which may include merchant information or other additional details. The “S” value represents special characters or symbols, like currency codes and separators. The “U” value represents track data (e.g., from a magnetic stripe of the card) or other purchaser-specific information. The “W” value represents alphanumeric data with extended character sets (e.g., non-Latin scripts). The “X,” “Y,” and “Z” values represent custom data that can vary based on network-specific requirements.

For example, during an authorization request there are times in which the merchant is requesting the address and postal code to be validated by the issuer (e.g., data element 48 sub element 82=52 (DE48s82=52), referred to as an Address Verification Service (AVS) check). The cardholder's address is populated within the authorization message within data element 120 (DE120). Additionally, the issuer populates a reason code (DE48s83) in the authorization request based on the outcome of their verification, the possible values are: (a) A: address matches, postal code does not; (b) N: neither address nor postal code matches; (c) R: retry, system unable to process; (d) S: AVS currently not supported, U.S. issuers will not be able to send through this response code; (e) U: no data from issuer/Authorization Platform; (f) W: for U.S. addresses, nine-digit postal code matches, address does not; for address outside the U.S., postal code matches, address does not; (g) X: for U.S. addresses, nine-digit postal code and address matches; for addresses outside the U.S., postal code and address match; (h) Y: for U.S. addresses, five-digit postal code and address matches; and (i) Z: for U.S. addresses, five-digit postal code matches, address does not.

A processing network operator is uniquely positioned to leverage this data to generate their own real-time system of known names and addresses based, for example, on payment data, where such a system is able to be used in providing a real-time service that accurately detects and identifies names and addresses by storing names passed in the transaction (e.g., DE45s5) as well as addresses (e.g., DE120) where the issuer responds with appropriate reason codes. As another example, an authorization request may be sent across the network for an individual named John Doe with an address of 123 Grayoaks Street, postal code 12345, which would be parsed as follows in connection with the corresponding DE's of an ISO 8583 message: (i) DE45s5: DOE/JOHN; (ii) DE48s82: 52; (iii) DE 120: 123 Grayoaks St 12345. The issuer validates the address and responds accordingly: (i) DE48s83: Y (e.g., a validity indicator). The system now knows that the address associated with John Doe is 123 Grayoaks Street 12345 and is accurate, and the authoritative database would be updated based on the confirmed accurate address. If an additional authorization request comes through with the following: (i) DE45s5: DOE/JOHN; (ii) DE48s82: 52; (iii) DE 120: 123 Grey Oaks Street 12345, the issuer validates the address and responds accordingly: DE48s83: Z (e.g., a validity indicator). The system now knows that the address associated with John Doe is not 123 Grey Oaks Street, however the postal code of 12345 is accurate. These techniques allow an entity such as a network operator to generate its own authoritative database of names and addresses without requiring additional computation or data sharing to happen from providers or customers. The contents of the authoritative database can be generated internally within existing data sets and sources.

The usage of the above-described transaction messages and corresponding DE's provides a basis for the systems and methods herein of normalizing user information and generating an authoritative database of verified user information for use in authorizing and authenticating payment transactions, which also has utility in fraud detection and prevention. With regard to extracting information from an ISO 8583 message, system tools can be set to identify country and address format of the specific country from authorization data. In one embodiment, a streamlined user interface or other protocols may be provided to permit easy normalization of data from various entities of the payment platform. For example, a normalization button may be present within a user interface in computer systems of the entities (e.g., network operator 106) shown in FIG. 1, where selection of the normalization button triggers a script or other program to execute to carry out the normalization according to the rules defined by the script/program.

In one embodiment, in response to a request message from a merchant, a response message includes normalized information that may be inserted into the same field as the source data from the original ISO 8583 message. In the case of the example above regarding “GRAYOAKS” and “GREY OAKS” street names, the proper format (“GRAYOAKS”) may be provided in the appropriate field so that the merchant knows the proper format (spacing and spelling) of the street name upon reviewing the response. This is beneficial because the issuer, for example, will not have to change anything on their end, as the normalized data will be ready for downstream use. However, it may be the case the normalized information introduces an error or is otherwise inaccurate, or that it is desired to keep the original data separate from any new (e.g., normalized) data.

To account for this scenario, in another embodiment, there may be a second field added in the ISO 8583 message, where the normalized information is inserted into the second field so that the original data in a first field of the message remains intact. This allows for the original data of the ISO 8583 message to remain unchanged (e.g., for record-keeping and/or legal purposes), while still providing the normalized information. For example, a data field for an address number may include a first address number field for the original address number as provided by the merchant, and a second data field for the address number that is inserted via adding the normalization information to the message as part of a response to the request message. For example, the first data field may be populated with an address number of “123----A”, whereas the second data field may be populated with a normalized version of the address number such as “123-A” where the extra dashes have been removed according to the normalization step(s) described herein. More specifically, with respect to an ISO 8583 message, using this data makes it is possible to provide a real-time tool or service that accurately detects and identifies names and addresses by storing the name and address passed in the transaction in the corresponding DE's, and where the issuer responds with the appropriate reason codes.

As described above, the embodiment of the normalization techniques described herein that includes linking/appending or otherwise modifying (e.g., enhancing) an ISO 8583 message with normalized information creates an enhanced ISO 8583 message, to be transmitted within the payment processing platform (e.g., transmitted as a response from the network operator to a request from the merchant). For example, the information in the merchant's request message may be left intact, and the normalized information may be linked/appended to the ISO 8583 message using adjacent or supplemental fields within the ISO 8583 message. This represents a significant improvement in electronic transaction messages used in the payment processing technology field as it creates an enhanced message conveying information that improves the ability to carry out transactions.

In operation, a requesting party of the payment platform permits the issuer to validate data. With respect to an ISO 8583 message, this is done, for example, at 48 settlement 82. The requesting party inputs a value of 52, prompting the issuer to verify the address. The requesting party then adds the address in a separate field of the message (e.g., the field in the ISO 8583 message that the issuer is validating). Such data includes name and postal code, for example, and may be referred to as AllNet 120 data. The issuer reviews the data and provides a response from a list of possible responses given the possible data scenarios. For example, it may be determined that (i) every combination of the address matched the postal code, (ii) nothing matched, or (iii) some other portion of data did/did not match. For example, in terms of a 9-digit postal code, the first 5 digits may match, but the last 4 digits may not match.

Entry of the data into an ISO 8583 message can be defined according to a specification. Because the ISO 8583 message may be configured as a single field, the positions for where to put certain elements can be set, for example, to accommodate regional nuances in address format. The information of the ISO 8583 message being in one field means it can be treated as a long string of data (e.g., character string). Certain positions within the string can be designated for certain types of data. For example, the specification may designate a certain number of positions to accommodate a street name, and require such data to be right justified. The designated number of positions can have as many digits as in the street address. In simpler terms, the field can be viewed as having certain buckets within the field for certain information to be placed. Within the one data field, the first 10 digits may be designated for a street number, and the next 5 digits may be designated to indicate an apartment or suite. In doing so, if there exists nuance in a certain market such as not having a postal code, or if the address information comes in a different order than expected, the specification would be able to account for such scenarios. Put another way, new fields do not have to be generated to accommodate such scenarios, rather, the positions within the field are adjusted to account for such scenarios, and normalization would be performed after such adjustment. Thus, regardless of the address format (e.g., due to territorial distinctions) the street number, for example, would be added to the same section of the ISO 8583 message. Then, once the data is normalized and has been verified, it can be flagged as being verified and added to the database for use in downstream applications such as subsequent authentications.

In one embodiment, the normalization tool could be configured as a value added service for the issuer to help them with the normalization process, as the issuer may already be doing forms of normalization at their end but may not be doing the best job at such normalization (e.g., not doing a good job of matching). More specifically, a processing network operator may provide normalization as a value-add to issuers, where the network operator normalizes data, such as address data for the issuer. In operation, during a transaction, the normalized data would be utilized for authentication, and then the processing network operator would wait for the issuer's response to determine what to do next because the issuer is still generally going to be the authoritative source on the data in such a scenario. This data may be leveraged by an entity such as a processing network operator in order to generate a real-time system of known names and their addresses based on payment data, where a primary value of reviewing the request message is normalizing it (e.g., for the issuer). Otherwise, the request could effectively be ignored, and the response would be the focal point. Regardless, the normalization and verified data manipulation and storage techniques disclosed herein are applicable to messages including request/response messages (e.g., add data as an enhanced ISO 8583 message in the request, wait for the response to validate, and then log the information).

In the process of determining if a certain piece of information has been verified, there may be a holding process where addition of the data to the verified database is delayed until verification is completed. For example, in connection with a request message, the waiting-to-be-verified data may be stored in separate location of the message. Such data may not be permitted to be added to the authoritative database until a response message is received. By normalizing and verifying data in the manner disclosed herein, the processing network operator can store authenticated address and name data in their own system for use within the payment platform.

Additional aspects of the authoritative database include the ability of the processing network operator to automatically update address information for related parties in the payment processing platform. For example, if a payment card consumer provides information of an address change, such an address change could trigger an automatic update to any merchant where the address that was updated is on file. An update could be pushed to any merchant that the network operator knows has such address information for updating of the address. Within the confines of the normalization scheme described herein, the updated address may only be pushed to merchants once the updated address is verified along the lines described herein (e.g., the updated address has become a verified address and is part of the authoritative source).

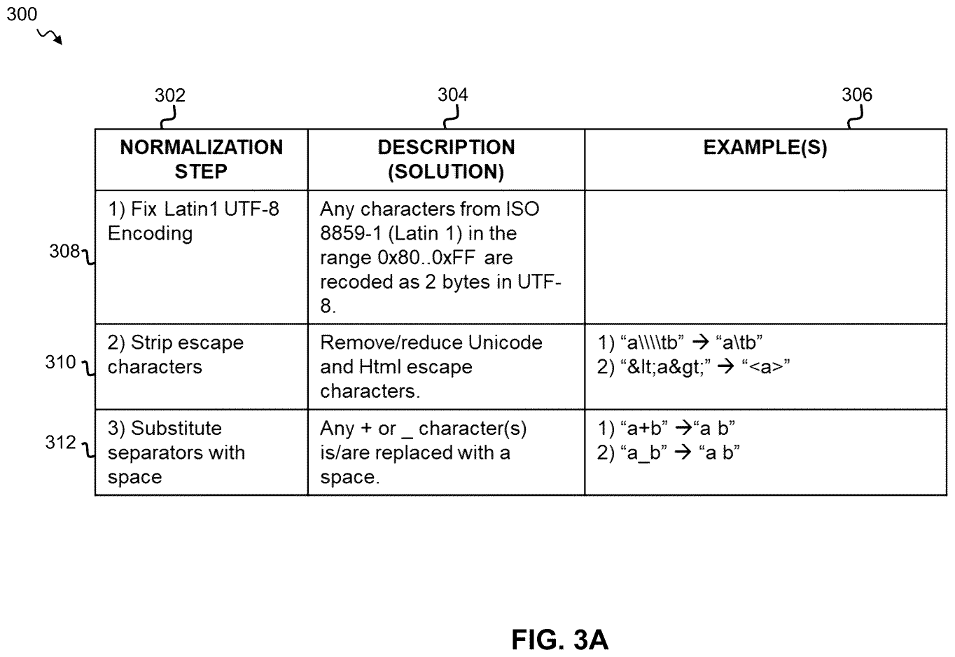

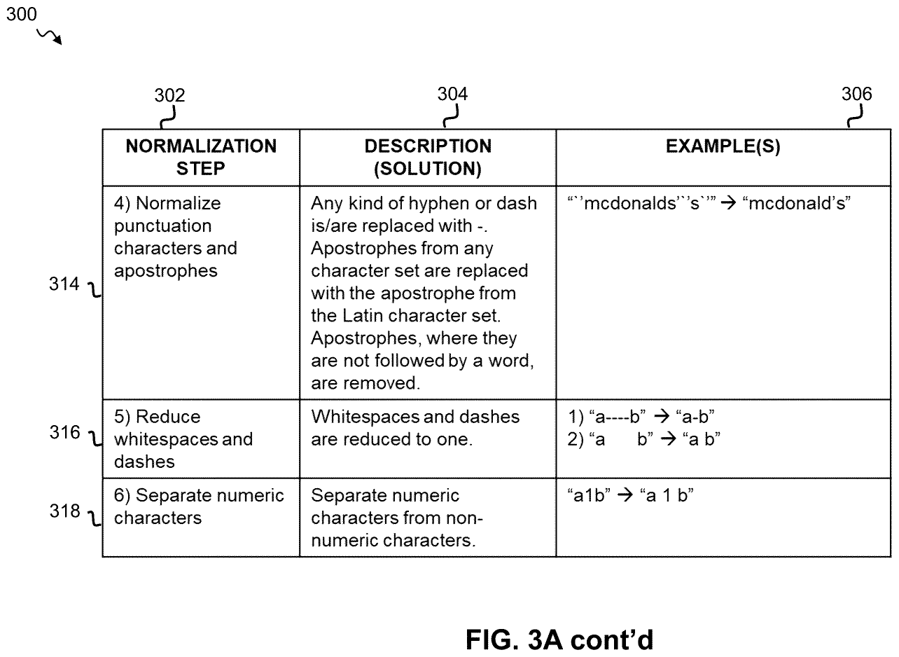

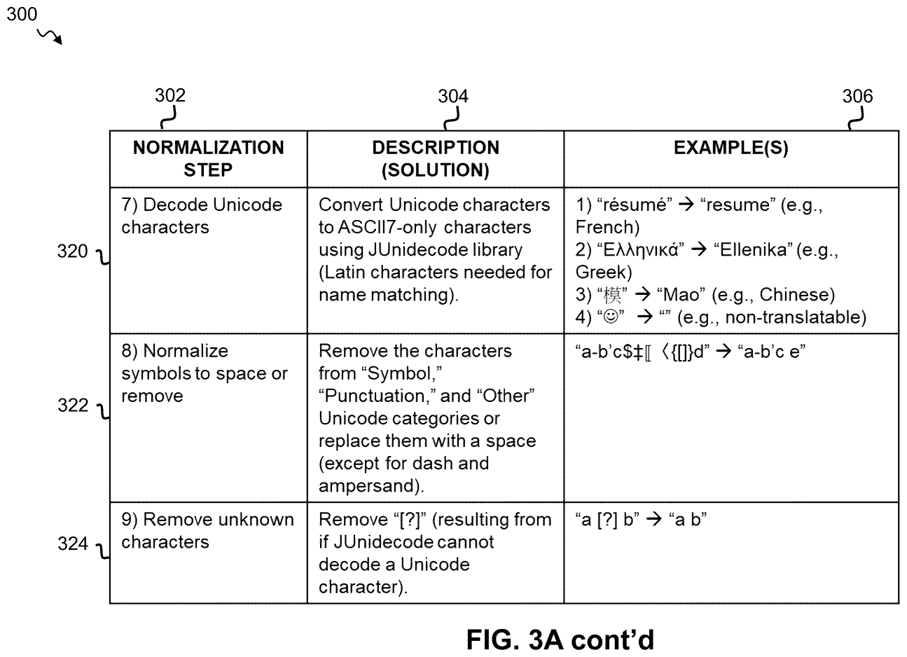

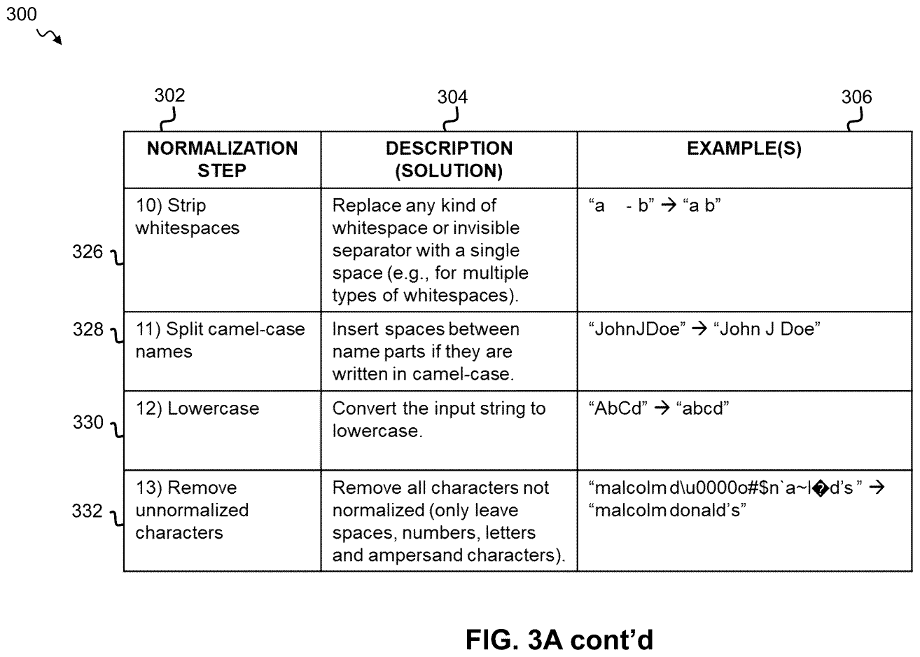

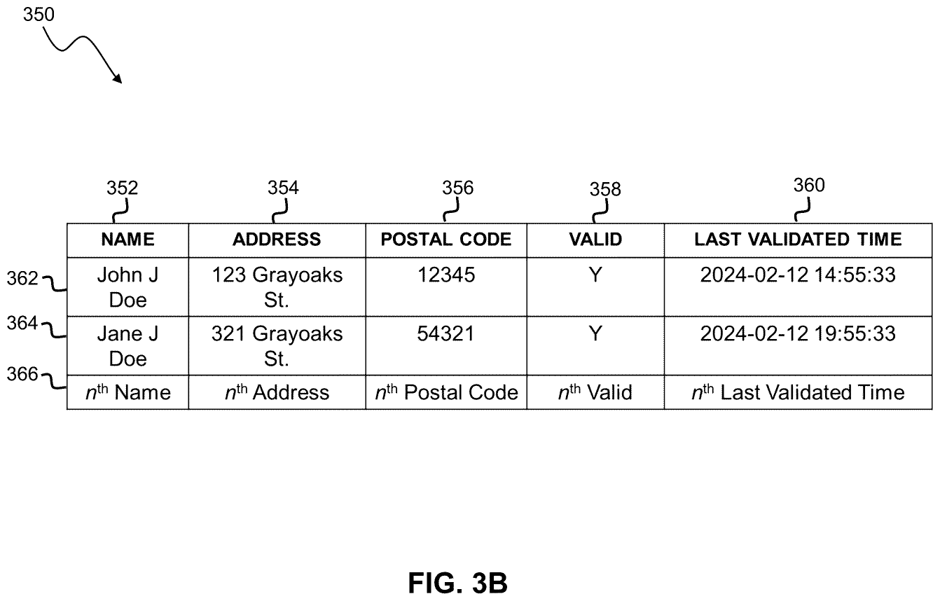

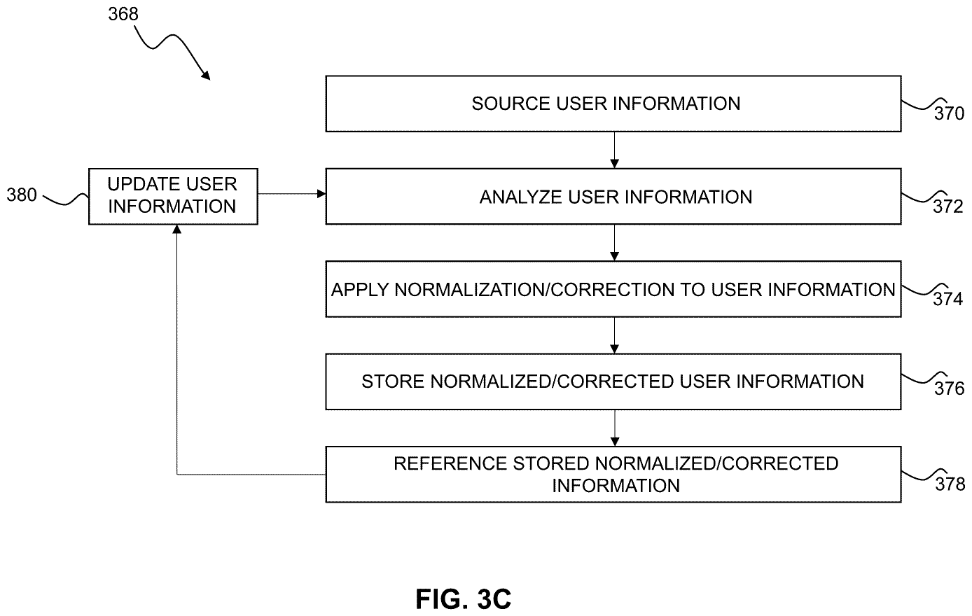

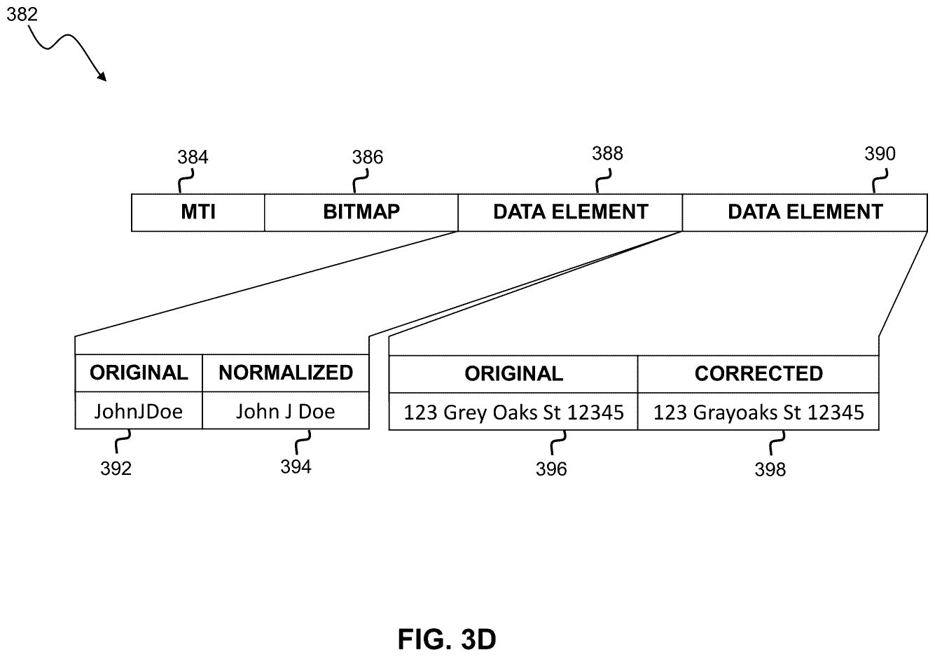

Additional aspects of the normalization process are provided as follows. A plurality of normalization steps is performed on names and/or address information acquired from multiple sources (e.g., names/addresses provided by data partners and/or names received in customer queries). The information normalized according to these steps therefore has the same acceptable format to perform matching via a matching algorithm. Personal identifiable information (PII) is part of transactions, and many signals regarding matching names, for example, are generated. Frequently, first and last names are not presented in a consistent manner, and/or are otherwise presented in differing formats, which introduces challenges with respect to normalization of such information. The normalization process has a plurality of steps to ensure that the names are in a single format to improve the ability to determines matches. In the context of names of businesses, this is even more challenging, as businesses may do business as other entities (e.g., DBA's, for example, subsidiary entities of a single larger corporation). This issue exists in the small business context as well. A business may have a front-facing name of “See Right Photography,” but may set up their business payment account using the name “MS Photography,” and the underlying business entity may be “See Right LLC.” The matching of such business names is able to be determined in the same general manner as names of individuals via the matching techniques described herein. Examples of normalization steps include but are not limited to: (1) fixing Latin1 UTF-8 encoding; 2) stripping escape characters; 3) substituting separators with space(s); 4) normalizing punctuation characters and apostrophes; 5) reducing whitespaces and dashes; 6) separating numeric characters; 7) decoding Unicode characters; 8) normalizing symbols to space(s); 9) removing unknown characters; 10) stripping whitespaces; 11) splitting camel-case names; 12) converting strings to lowercase; and 13) removing unnormalized characters. These normalization steps are described in greater detail below in connection with FIG. 3A.

Another aspect and benefit of having an authoritative database of verified user information is that the operator of the authoritative database (e.g., the network operator) may, by virtue of the veracity of the information in the authoritative database, be permitted to “stand-in” for an entity within the payment platform that, for one reason or another, is unavailable to participate in a particular transaction. For example, the processing network operator may stand in place of the issuer and act as the issuer in scenarios where the issuer's systems are down, which could be for a variety of reasons (e.g., technical issues, message timed out, systems are down due to an attack). It is known that issuers may be victims of attacks that attempt to overwhelm their systems, where nefarious entities may then attempt to leverage the overwhelmed system to process (e.g., fraudulent) transactions that would have normally been declined if the system were under normal load/stress. In any given year, attacks on issuers can result in large amounts (e.g., tens of millions) of transactions where the issuer is unable to respond.

In view of this, an issuer may grant the processing network operator permission to respond on its behalf using information from the authoritative database when the issuer is unavailable to respond. In a scenario where the issuer suffers an outage or other event that renders them unable to participate in a transaction (e.g., unable to respond to message), the network operator, acting as an authoritative source via use of the authoritative database, can stand-in for the issuer to help process the transaction. For example, in a transaction at a merchant, the data that the merchant has on file may get sent to an issuer in an ISO 8583 message. If the message for some reason times out, bounces back, or is otherwise not acted upon by the issuer, the issuer may give permission for the network operator to stand-in for the issuer, to compare the data of the present transaction to the verified data in the authoritative database, and approve or decline the transaction via standing in the place of the issuer. The ability to stand-in for an entity such as an issuer represents a significant improvement to the payment processing technology field as it improves the ability for transactions to be completed and reduces the number of messages processed over the network.

In a scenario where a merchant requests an address check to validate information before approving a transaction, and the issuer is unable or unavailable to respond to the address request, the merchant is faced with a decision to (i) take the risk and permit the transaction without having the confirmation that would have been provided via the issuer's response to the address request, or (ii) decline the transaction since they did not receive the response. By virtue of the network operator being able to stand-in for the issuer due to the authoritative information in the network operator's authoritative database, such transactions are less likely to be declined by the merchant, since the network operator is able to provide the (e.g., address) confirmation that the merchant was seeking in order to be more comfortable in approving the transaction. The processing network operator may provide an approval or decline decision on behalf of the issuer so that the transaction can get processed, and so that purchasers are not sitting and waiting at a merchant (e.g., retailer), not knowing if they are able to purchase goods or not. The network operator stands in on behalf of the issuer and makes the decision with the authoritative data. Without such stand-in techniques described herein, a request for a verified address when an issuer is non-responsive, a network operator (e.g., card network operator) would essentially have to reply that the issuer is down, and would be unable to tell a merchant anything about the address at issue in the transaction, impacting the ability to complete transactions (where completing transactions is a major goal of a payment processing system).

The ability of the processing network operator to stand-in for the issuer is a beneficial service that is usable to assist with verifications such as whether the billing address matches what is on file at the (e.g., issuer) bank. This stand-on service allows the network operator to provide such confirmation even when the issuer's system is down or the issuer is otherwise unable to respond in order to be able to complete the transaction, and helps bona fide transactions (that might have been declined due to the unavailability of the issuer) be approved. By leveraging the address information it has available from its records in order to validate the address information and populate a valid accurate response when the issuer is unable to respond to the message, the processing operator can perform the value-added, enhanced service for issuers. Because the authoritative database includes verified data that serves as an authoritative source of the address (by virtue of the network operator knowing the address is valid from when the credit card was signed up for and activated by the cardholder), the issuer can trust the processing network operator to stand-in for the issuer and provide a reason code in an ISO 8583 message indicating whether or not the address is accurate. Because this data may be updated in real-time as messages flow, the processing network operator no longer needs to verify the authenticity and/or accuracy of the data from a third-party source which can introduce delays and add significant cost. Rather, the network operator can simply provide the verified (and/or normalized) information itself in responding to messages.

The issuer may require the stand-in process operate according to a set of rules, including restrictions for certain transaction dollar amounts and rules for other aspects of a transaction, for example. In operation, regardless of whether the address was verified or not, certain transactions may be declined based on violating such rules, and a response would be sent that indicates that the address was a match, but that some other rule was violated (e.g., in such a case the merchant would be able to view the address and rule information separately). For example, if a $1 million transaction is made (and no similar transaction has been made or permitted in the past), such a transaction is likely to be declined based on the high dollar amount alone, but the processing network operator will still respond to the merchant that the address did/did not match. The rules for transaction amounts may include thresholds where transactions beneath a certain threshold level are categorically permitted, and those above the threshold level are not (e.g., the issuer may have a rule that (i) so long as the amount is $1,000 or under, and (ii) all other transaction information (e.g., name, address) matches, the transaction should be permitted).

On the other hand, the issuer may have a rule that even if the various transaction information (e.g., name, address) is determined to be a match, any amount over $1,000 should be declined. This can be realized through tools such as a fraud rules manager (FRM), which may include a portal that an issuer uses to establish rules for transaction parameters. Such an FRM tool could be implemented into the authoritative database described herein to assist with the execution of the stand-in aspects as described herein. For example, in addition to the transactional rules described above, the rules may also include rules to follow when the issuer is suffering an outage or is otherwise unable to participate in the transaction process. The FRM may include certain signals and/or parameters that the issuer wants to be in effect (e.g., the network operator is only permitted to stand-in after two failed attempts to get a response from the issuer). Recalling the prior example, the processing network operator, standing in for the issuer and based on the FRM rules, may determine that if the transaction amount is under $1,000 and the address is a match, approval will occur. The processing network operator may only know of the issuer being down when the issuer is pinged (and does not respond) during the transaction process, and so the stand-in aspects would be a real-time solution to the problems experienced from an unavailable issuer (e.g., helping the transaction process to flow in a mostly uninterrupted manner, thereby improving transaction processing).

Further regarding fraud, address data is a core data point that is analyzed in connection with fraud, and has its own set of signals and risks associated with names, IP addresses, etc. This information can be linked and/or cross-referenced with information from other observed/detected behaviors, such as how many times a certain name and address combination has been promulgated through the processing network. This may include information relating to how many different purchaser names have recently been used in connection with a particular address, and whether any of the name/address combinations resulted in a bona fide transaction or were flagged as fraud. Such analysis is conducted with address data across the board to provide a variety of fraud prevention, and in particular as part of onboarding services, such as in the credit card account opening process. Any such combination may be checked against the valid information of the authoritative database, updated for accuracy as needed based on a comparison with the information in the authoritative database, and then saved and utilized for fraud prevention/detection purposes the next time a transaction comes through.

If, for example, an account number and address combination comes through as part of a transaction but the name does not match, such a non-matching combination may generate a negative signal (e.g., flag) for fraud detection purposes, indicating a potential risk. A message could be sent to the merchant that the name is not a match and/or this particular name has not been used in the past with that address. For example, in a scenario where a purchaser has moved to a new residence, the purchaser's address information may have been updated with respect to the purchaser's bank account, but not for the address information stored at a particular merchant (e.g., the merchant has outdated address information). In such a scenario, the merchant may determine whether or not the non-matching information is a high enough risk signal to take action on. The merchant could ask for re-entry of the address information, or the merchant may come to the conclusion that because the purchaser has a longstanding relationship with the merchant, and the merchant has seen other scenarios where certain information does not match, the transaction will be sent through for processing. Thus, while the message that is sent back to the merchant would indicate that there is non-matching information, the merchant can choose to proceed with the transaction in a manner of their choosing (e.g., either decline or approve the transaction). The combination of the internal knowledge of the network operator, their expertise in being able to determine bona fide name/address and/or other transaction data, and the verified data present in the authoritative database greatly improves the detection/prevention of fraud, and represents a significant improvement in fraud technology in the payment processing technology field.

A technical effect of the systems and methods described herein is achieved by performing at least one of the following steps: (a) creating a data normalization standard for normalization of transaction data, (b) creating an authoritative database of transaction data that has been verified by entities within a payment processing system and normalized according to a data normalization standard; (c) creating an enhanced ISO message including normalized and verified transaction data; (d) generating match signals based on normalized and verified transaction data; (e) standing-in for an entity (e.g., issuer) that is part of a transaction (where the entity is unable to participate in processing a transaction) by sending messages on behalf of the entity; (f) enhanced fraud detection and prevention based on comparisons with normalized and verified transaction data present in an authoritative database; (g) use of fuzzy logic in verifying transaction data; (h) reduction in fraud where transaction information cannot be verified when an entity (e.g., issuer) participating in a transaction is unresponsive; (i) reduction in fraud where certain information (e.g., name information) is used to generate fraud signals; (j) providing real-time responses to transaction requests; and (k) improved matching algorithms (e.g., for matching names, addresses, etc.). More generally, a technical effect of the systems and methods described herein include improvements in the processing of transaction information in a processing network, in the processing of transactions in a processing network, in the processing systems for a processing network, and in the enhanced electronic messages transmitted and received in a processing network.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers, without limitation. Each type of transactions card can be used as a method of payment for performing a transaction. The terms “verify”/“verified”/“verification” may be used interchangeably with “validate”/“validated”/“validation” herein.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

In one embodiment, a computer program is provided, and the program is embodied on a computer readable storage medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable storage medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

FIG. 1 illustrates a schematic diagram of an example multi-party payment account system 100 (e.g., platform) for enabling payment transactions initiated by cardholders 102 (e.g., users/purchasers 102) over a payment processing network 104 associated with a network operator 106 (e.g., a card network operator) and that is in communication and used in conjunction with a normalization and validation computing system 108 (also referred to as (i) N&V computing system 108, (ii) normalization and validation computing device 108, (iii) N&V computing device 108). As described below in more detail, N&V computing system 108 is configured to both normalize internal transaction information of network operator and/or normalize data collected from entities of system 100 (for example from a merchant 110 (e.g., transaction data, operations data)) to improve a service function (“normalization service”) performed and provided by N&V computing system 108. N&V computing system 108 may also assist with the performing of other functions, including a function to authenticate user 102 through the use of an authentication protocol, and, once user 102 has been authenticated, transmit an authentication message to payment processing network 104 (e.g., an interchange network 104, or simply interchange 104) for further processing of the transaction. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, N&V computing system 108 is communicatively and operatively coupled to processing network 104, network operator 106, merchant 110, merchant bank 112, and an issuer 114 (issuer 114 may be referred to as issuer bank 114). As used herein, merchant 110 and issuer 114 may be directly connected to N&V computing system 108, may be indirectly connected to N&V computing system 108 through payment processing network 104, or may be connected through another computing system of network operator 106.

In the example embodiment, a financial institution called the “issuer” or “issuing bank” issues an account 116, such as a credit card account, a debit account, or a prepaid card account to cardholder 102, who uses the account to tender payment for a purchase from a merchant 110. In one embodiment, cardholder 102 presents a payment card and/or a digital wallet linked to a card or account to merchant 110 using a transaction device (also known as card-present transactions). In another embodiment, the user does not present a physical payment device, and instead performs a card-not-present transaction. For example, the card-not-present transaction may be initiated via a digital wallet application, through a website or web portal, via telephone, or any other method that does not require the user to present a physical payment card to merchant 110 (e.g., via swiping or inserting the payment card and/or scanning the digital wallet).

To accept payment with the transaction card, merchant 110 establishes an account with a financial institution that is part of the financial payment system. This financial institution is usually called the “merchant bank” (e.g., merchant bank 112), the “acquiring bank,” or the “acquirer.” In one embodiment, cardholder 102 tenders payment for a purchase using a transaction card at a transaction processing device 118, then merchant 110 requests authorization from merchant bank 112 for the amount of the purchase. Transaction processing device 118 (e.g., transaction device 118) may be a point-of-sale (POS) device (e.g., POS terminal) in an in-store context, or a mobile computing device (e.g., mobile phone) of user 102 or desktop/laptop computer of user 102 in an at-home (e.g., online shopping) context. The request is usually performed through the use of a POS device, which reads account information of cardholder 102 from a magnetic stripe, a chip, barcode, or embossed characters on the transaction card (e.g., a debit card or a prepaid card) and communicates electronically with the transaction processing computers of merchant bank 112. Alternatively, merchant bank 112 may authorize a third party to perform transaction processing on its behalf. In this case, a POS terminal will be configured to communicate with the third party. Such a third party is usually called a “merchant processor,” an “acquiring processor,” or a “third party processor.” The merchant processor, acquiring processor, third party processor, as well as merchant 110 and merchant bank 112, may also be referred to as a “requesting party.”

In the example embodiment, merchant 110 communicates, either directly or indirectly (e.g., via processing network 104), with other (e.g., sub-) systems within system 100, where such other (sub-) systems may be utilized to authenticate cardholder 102 before the transaction is further processed or to assist an authentication aspect or device that is part of the multi-party payment account system 100 shown in FIG. 1 in authenticating cardholder 102. For example, N&V computing system 108 may authenticate cardholder 102 in the manner described herein. Once cardholder 102 has been authenticated, using processing network 104, computers of merchant bank 112 (or a merchant processor) will communicate with computers of an issuer 114 to determine whether account 116 (e.g., user account) of cardholder 102 is in good standing and whether the purchase is covered by an available credit line of cardholder 102. Based on these and other determinations, the request for authorization will be declined or accepted. If the request is accepted, an authorization code (e.g., included in an authorization message) is issued to merchant 110. An authorization message includes a transaction identifier associated with the transaction and an indicator indicating that the transaction was authorized. If the request is not accepted, the authorization message includes a transaction identifier associated with the transaction and an indicator indicating that the transaction was declined. In the example embodiment, authorization message is formatted according to ISO 8583 network messaging protocol, or the equivalent messaging protocol used by the payment card processing network. For example, as described herein, ISO 20022 network messaging protocol may additionally or alternatively be utilized.

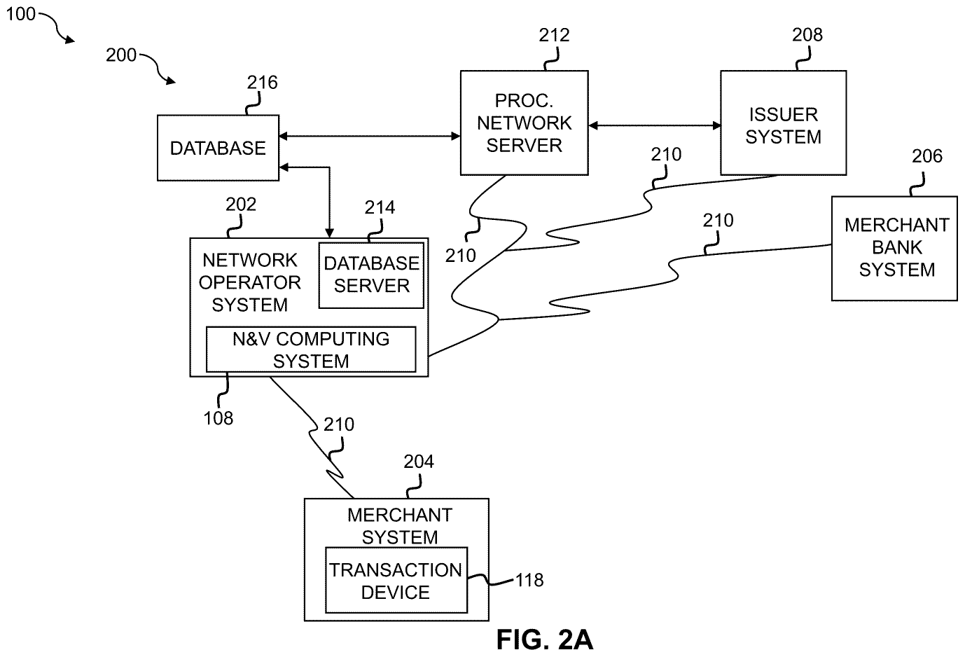

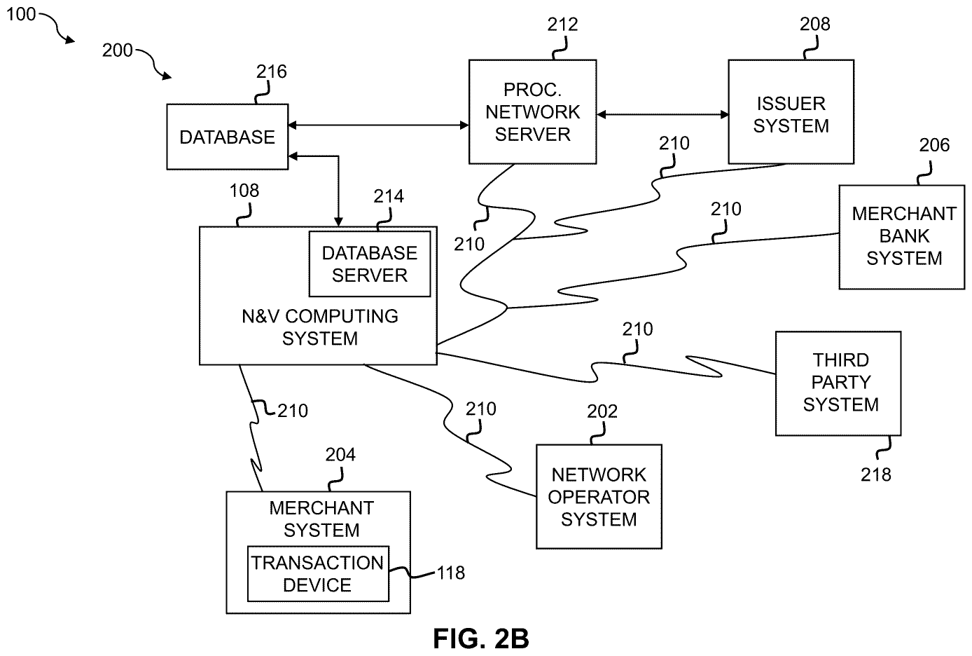

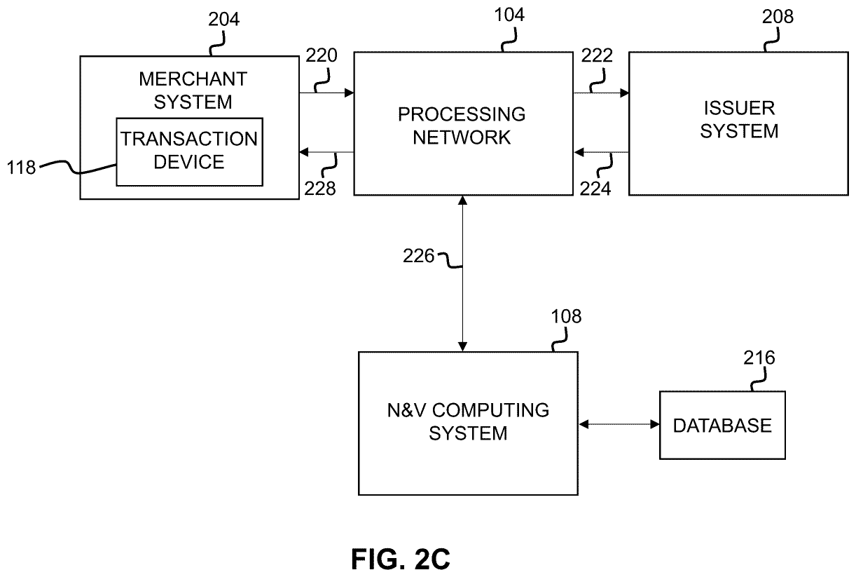

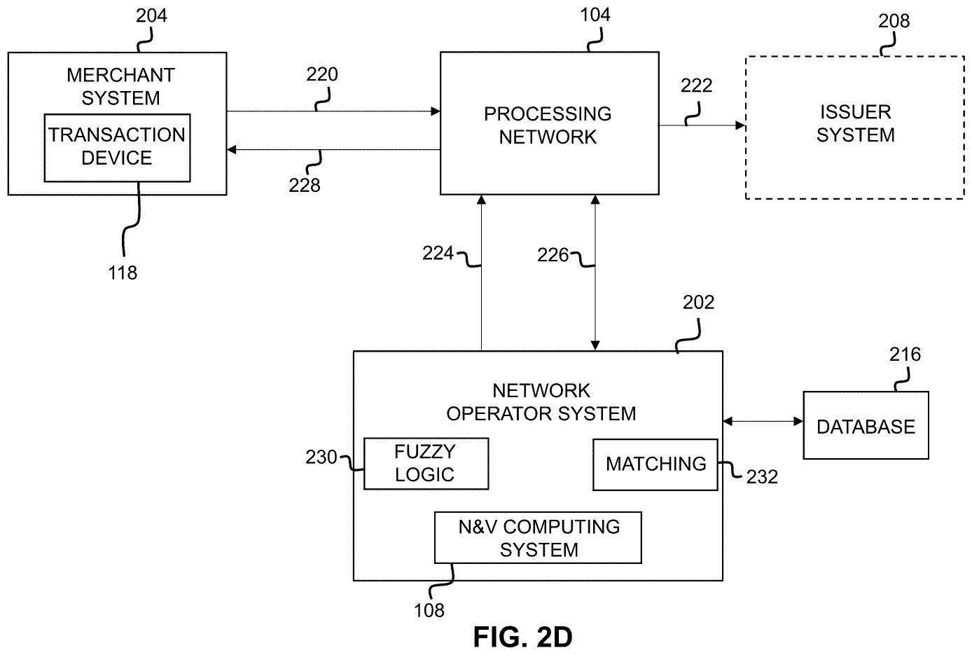

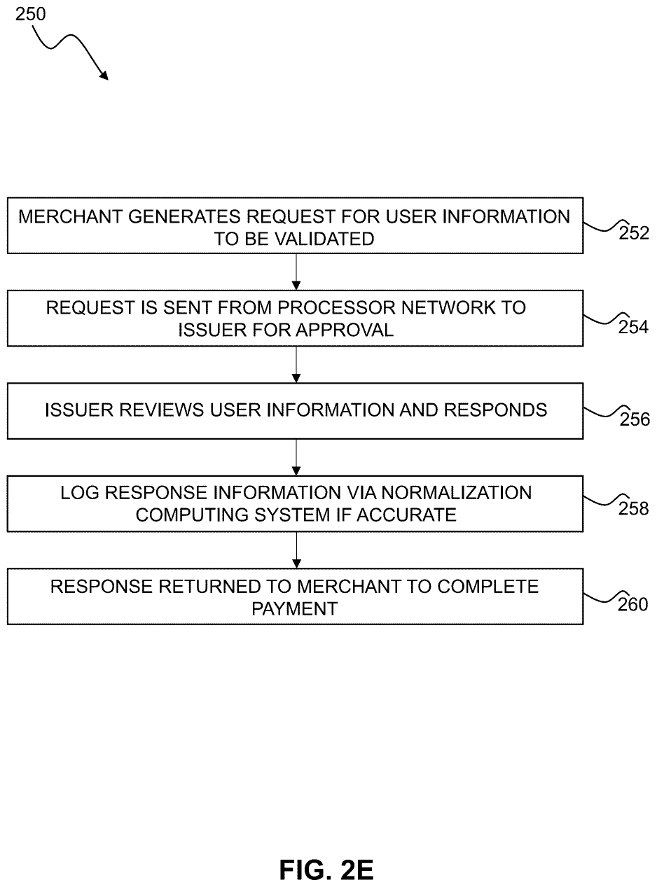

When a request for authorization is accepted, the available credit line of account 116 of cardholder 102 is decreased. Normally, a charge for a payment card transaction is not posted immediately to account 116 of cardholder 102 because certain rules do not allow merchant 110 to charge, or “capture,” a transaction until goods are shipped or services are delivered. However, with respect to at least some debit card transactions, a charge may be posted at the time of the transaction. When merchant 110 ships or delivers the goods or services, merchant 110 captures the transaction by, for example, appropriate data entry procedures on the POS terminal. This may include bundling of approved transactions daily for standard retail purchases. If cardholder 102 cancels a transaction before it is captured, a “void” is generated. If cardholder 102 returns goods after the transaction has been captured, a “credit” is generated. Processing network 104 and/or issuer 114 stores the transaction card information, such as a type of merchant, amount of purchase, date of purchase, etc. in a database (e.g., database 216, shown in FIG. 2).

After a purchase has been made, a clearing process occurs to transfer additional transaction data related to the purchase among the parties to the transaction, such as merchant bank 112, processing network 104, and issuer 114. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol, or the equivalent messaging protocol used by the payment card processing network.

After a transaction is authorized and cleared, the transaction is settled among merchant 110, merchant bank 112, and issuer 114. Settlement refers to the transfer of financial data or funds among account of merchant 110, merchant bank 112, and issuer 114 related to the transaction. Usually, transactions are captured and accumulated into a “batch,” which is settled as a group. More specifically, a transaction is typically settled between issuer 114 and processing network 104, and then between processing network 104 and merchant bank 112, and then between merchant bank 112 and merchant 110.

As described above, the various parties to the payment card transaction include one or more of the parties and/or systems shown in FIG. 1 such as, for example, cardholder 102, network operator 106, merchant 110, merchant bank 112, processing network 104 (also referred to herein as network operator processing network 104), issuer 114, and/or an issuer processor 120. A transaction may be referred to in a temporal manner, such a historical (e.g., past or prior) transactions, current, or live (e.g., a transaction that may be occurring at any given live moment).

FIG. 2A is an expanded block diagram of an example embodiment of sub-system 200 within payment system 100 that utilizes N&V computing system 108 for providing the normalization service as described herein. More specifically, in the example embodiment, system 200 includes N&V computing system 108 that is provided, for example, by network operator 106, and a plurality of client sub-systems connected to N&V computing system 108. N&V computing system 108 is operatively and integrally coupled to network operator system 202 (also referred to as network operator computing device 202 or card network operator system 202). For example, since network operator 106 is one of the parties of system 100 best-suited to provide the normalization service, normalization computer system 108 may be an integral part of network operator system 202. Client sub-systems include merchant system 204 (also referred to as merchant computing device 204), merchant bank system 206 (also referred to as merchant bank computing device 206), and issuer system 208 (also referred to as issuer computing device 208). In one embodiment, client sub-systems 204, 206, and 208 are computers including a web browser, such that N&V computing system 108 is accessible to client sub-systems 204, 206, and 208 using the Internet and/or using a network. In other embodiments, client sub-systems 204, 206, and 208 are computing programs (e.g., applications) provided within devices.

Client sub-systems 204, 206, and 208 are connected to the Internet through many interfaces including a network 210, such as a local area network (LAN) or a wide area network (WAN), dial-in-connections, cable modems, special high-speed Integrated Services Digital Network (ISDN) lines, and RDT networks. Issuer system 208 includes systems associated with issuer 114 (shown in FIG. 1) as well as external systems used to store data. Merchant system 204 includes systems associated with merchants 110 (shown in FIG. 1) as well as external systems used to store data. For example, transaction device 118 of merchant system 204 may include a POS terminal communicatively and operatively coupled to an external system of merchant 110. Transaction device 118 may also include a user device (e.g., a user's computer, mobile phone, or other (e.g., internet-connected) smart device) that is used to purchase goods/services from a merchant 110. For example, a POS terminal of a merchant 110 (and/or another merchant computing device) generates a payment authorization request message (e.g., an ISO 8583 computer message) that includes a transaction secure token, and transmits the payment authorization request message to the payment processing network for further processing. In one example, a payment transaction authorization request includes a plurality of data elements which conforms to follow contents and formats as defined in Customer Interface Specification (CIS) specification for authorization messages. Merchant bank computing device 206 includes systems associated with merchant banks 112 (shown in FIG. 1) as well as external systems used to store data. N&V computing system 108 is also in communication with a processing network server 212 (also referred to as a payment processing device 212) associated with processing network 104 (also referred to as interchange/interchange network 104) (shown in FIG. 1) using network 210. In one embodiment, a computing system of N&V computing system 108 may be part of the same overall system as processing network 104. Further, client sub-systems 204, 206, and 208 may additionally communicate with interchange 104 using network 210. In more general terms, client sub-systems 204, 206, and 208 could be any device capable of interconnecting to the Internet including a web-based (e.g., mobile) phone, PDA, smart devices, or any other web-based connectable equipment. For example, a user computing device and POS terminal are, without limitation, embodiments of transaction device 118 (shown in FIG. 1).

A database server 214 of network operator system 202 (and/or normalization computer system 108) is connected to a database 216 which contains information and data on a variety of matters (database 216 may be a centralized database). For example, database 216 may store transaction data and rules regarding parameters of generating normalized data, and server 212 may provide access to such data and rules stored in database 216. In one embodiment, database 214 server is stored on N&V computing system 108 (as shown in FIG. 2B) and can be accessed by potential users at one of client sub-systems 204, 206, and 208 by logging onto N&V computing system 108 through one of client sub-systems 204, 206, and 208. Access to database 216 may be controlled by N&V computing system 108 to limit the display of data to authorized users enrolled with N&V computing system 108. In an alternative embodiment, database 216 is stored remotely from N&V computing system 108 and may be non-centralized. Database 216 may be a database configured to store information used by N&V computing system 108 including, for example, current transaction data, prompt data, other user data, historical transaction data, and normalization rules and validation to be used as part of the normalization service, and/or other applicable data.

Database 216 may include a single database having separated sections or partitions, or may include multiple databases, each being separate from each other. In some embodiments, database 216 stores transaction data generated over the processing network including data relating to merchants, purchasers, account holders, prospective customers, issuers, acquirers, and/or purchases made. Database 216 may include multiple storage units such as hard disks or solid state disks in a redundant array of inexpensive disks (RAID) configuration, and may include a storage area network (SAN) and/or a network attached storage (NAS) system. Database 216 may be referred to as a normalized user data database and/or a validated user (or cardholder) database. Database 216 may be partitioned to function as a normalized user data database and a validated user database. Alternatively, normalized user data database may be realized by a database separate from a database used to realize a validated user database. Regardless, database 216 and any other database will be configured as shown in FIGS. 2A to 2D and as described herein, e.g., to be in operative communication with the applicable systems/components (e.g., 108, 202, 212, 214) for storage of data of system 100.

The systems (e.g., 108, 202, 204, 206, 208), networks (e.g., 210) and servers (e.g., 212, 214), and various databases (e.g., 216) shown in FIG. 2A provide for the implementation of the normalization service described herein, as described below in more detail. While FIG. 2A only show(s) two-way communication arrows between blocks 202, 208, 212, and 216, any block connected via network 210 may be capable of such two-way communication (likewise for the blocks shown in FIG. 2B).

FIG. 2B illustrates an expanded block diagram of an example embodiment of payment sub-system 200 within system 100 utilizing N&V computing system 108 for providing the normalization service as in FIG. 2A, except payment sub-system 200 has been modified to account for third parties that may be part of payment sub-system 200. As shown in FIG. 2B, third party system 218 (also referred to as third party computing device 218) is provided. With respect to third parties, as described herein, merchant bank 112 may authorize a third party (e.g., a “merchant processor,” an “acquiring processor,” or a “third party processor”) to perform transaction processing on its behalf, for example. Additionally, as described herein, name and/or address information may be obtained from sources such as government records (e.g., census data, voter rolls, other registry data) and entities such as utility companies, health care providers, and/or other data partners or vendors such as “data brokers.” These other (e.g., data source) entities may also be referred to as a third party/parties. Third party system 218 represents systems of any of one or more third parties that may be utilized or otherwise permitted to participate in system 100 and/or sub-system 200. As further shown in FIG. 2B, normalization computer system 108 is not integrally coupled with network operator system 202 (e.g., as compared to the configuration shown in FIG. 2A). This configuration is optional and merely reflects potential additional flexibility of the configuration of the components of sub-system 200 in view of the presence of a third party (e.g., third party system 218) in sub-system 200 or other desired configuration. Messages and/or other communications between the parties in FIGS. 2A and 2B may be in the form of ISO 8583 or ISO 20022 messages as described herein.

FIG. 2C illustrates a block diagram of an example embodiment of a transaction processed in connection with N&V computing system 108 in accordance with one example embodiment of the present disclosure. An authorization request message 220 (e.g., request 220) is generated at merchant system 204 with an indicator that merchant 110 would like certain provided information (e.g., the provided address) of purchaser 102 to be validated. This request 220 is received by processing network 104 and passed along as request message 222 (e.g., request 222) to issuer 114 for approval. Request message 220 and request message 222 may contain essentially the same information therein. Issuer 114 reviews the address (e.g., by checking the address against its address records) and sends a response message 224 with an appropriate reason code. For example, the reason code may convey a “YES” or “NO” response in connection with a validation request of data of any particular data element, in accordance with ISO 8583 protocols. Response message 224 (e.g., response 224) is received by N&V computing system 108 of network operator 106 via communication message 226 (e.g., communication 226), and N&V computing system 108 logs the address in an authoritative database (e.g., database 216) if response 224 from issuer 114 indicates that the address was accurate (otherwise, response 224 may simply be passed along as message 228 to merchant 110 as a response message 228 (e.g., response 228) in order to complete the payment as normal). Response 228 may be referred to as a replicated response message 228 if it is determined that the information in request 220 matches information stored by issuer 114 (e.g., where there is no need to provide updated/corrected/normalized information in response to message 220). Response 228 may be referred to as an enhanced response message a match is determined to not be present (e.g., enhanced response message 228 would include normalized information linked/appended thereto (or otherwise provided with response 228), as described herein). If response 224 indicates that the address was not accurate, the address would not be logged by N&V computing system 108. While FIG. 2C shows database 216 as the database used for storing authoritative address data, a different database may be used, such as a dedicated database configured to function as an authoritative database for storing normalized and verified name, address, and other transactional information (e.g., normalized verified addresses as in the provided examples herein, as well as verified name and postal code information). Each of the requests/responses/communications (e.g., 220, 222, 224, 226, 228) shown in FIG. 2C and described in connection therewith may be an ISO 8583 message as described herein.

N&V computing system 108 may function as a pass through vessel of sorts, generally mirroring the function of processing network 104. For example, the manner in which response 224 is passed through network 104 may generally be the manner in which response 224 may pass through N&V computing system 108, except that N&V computing system 108 is also configured to extract validity information from response 224. For example, communication 226 is configured as send and receive (e.g., see double arrow of 226). Alternatively, network operator system 202 may function as a pass through, as described below. While FIG. 2C focuses on address information, FIG. 2C applies equally to name information and/or other transaction information. Additional aspects of the normalization of the name and address information are described below.

Response 228 may be configured as a modified (e.g., enhanced) ISO 8583 message. For example, response 228 may package the new, validated and normalized data as an addendum or other add-on to the original ISO 8583 message (e.g., message 220) of the transaction. This would allow for the original information included in message 220 to remain present, while still providing the new verified and normalized information to merchant 110. This may be beneficial for record-keeping purposes, as the original data is maintained, or may be of other benefit to merchant 110 (e.g., to more easily compare the original information and the addendum information). For example, instead of overwriting the original information in message 220 with the new information, the enhanced message (e.g., 228) includes both the original information and the new information.

FIG. 2D illustrates an example embodiment of a stand-in procedure according to one example embodiment of the present disclosure. FIG. 2D is similar to FIG. 2C, except that issuer 114 is unavailable to participate in the transaction, and N&V computing system 108 is shown as being integrated into network operator system 202 (such as shown in FIG. 2A). As described above, issuer 114 may have suffered an outage such that issuer system 208 is unavailable/unable to provide a response to message 222 (illustrated by the dashed line of the box for issuer system 208 in FIG. 2D). In such a scenario, issuer 114 may permit network operator 106 to stand-in for issuer 114. Given that a primary goal of N&V computing system 108 is to generate normalized information that is verified and then used to populate an authoritative database (e.g., database 216) containing the validated information, issuer 114 would be enticed to trust network operator 106 to stand-in for issuer 114 because of the reliability of the data coming from the authoritative database (e.g., for the reasons described herein). As shown in FIG. 2D, and in comparison to FIG. 2C, message 224 is sent from network operator system 202 of network operator 106 instead of from issuer system 208 (due to issuer 114 being down). Alternatively, message 224 could be incorporated into message 226. Regardless, the applicable information included within message 224/226 ends up being transmitted in response 228 to merchant 110. Each of the requests/responses/communications (e.g., 220, 222, 224, 226, 228) shown in FIG. 2D and described in connection therewith may be an ISO 8583 message as described herein.

Network operator system 202 may function as a pass through vessel of sorts, generally mirroring the function of processing network 104. For example, the manner in which response 224 is passed through network 104 is generally the same in which response 224 may pass through network operator system 202, except that network operator system 202 is also configured to extract validity information from response 224. For example, note that communication 226 is configured as send and receive (e.g., see double arrow of 226).

Network operator system 202 may also include a fuzzy logic module 230 therein, as shown in FIG. 2D. Alternatively, this fuzzy logic module 230 could be incorporated into N&V computing system 108. Fuzzy logic module 230 helps with correcting information that can be corrected, for example, based on other known information (e.g., using partial truths). For example, fuzzy logic module 230 is capable of determining that a subset of cardholder (e.g., user) address data, such as the street name of an address of “123 Grey Oaks St.” as listed in a message (e.g., message 220) is inaccurate and needs to be corrected to “123 Grayoaks St.” This determination may be based on items such as (i) the address “123 Grey Oaks St.” does not exist, (ii) the other provided information (e.g., name, postal code) is accurate, and/or (iii) “Grey Oaks” is similar to “Grayoaks.” Fuzzy logic module 230 may include algorithms designed to carry out such functions. Fuzzy logic module 230 may be utilized in any applicable systems as shown/described herein (e.g., system(s) 200 of FIGS. 2A-2C).

Network operator system 202 may also include a matching module 232 therein, as shown in FIG. 2D. Alternatively, this matching module 232 could be incorporated into N&V computing system 108. Matching module 232 determines, for example, matches between information present in a request from merchant 110 (e.g., information in message 220) and information stored in the authoritative database (e.g., database 216). This is particularly helpful in a stand-in scenario where issuer 114 is not available (e.g., as shown in FIG. 2D). Matching module 232 may be programed with matching algorithms designed to carry out various matching functions, as described herein. Matching module 232 may be utilized in any applicable systems as shown/described herein (e.g., system(s) 200 of FIGS. 2A-2C). Matching module 232 may be independent of fuzzy logic module 230 or used in conjunction with or otherwise supplemented by fuzzy logic module 230. For example, fuzzy logic module 230 may be configured to assist matching module 232 with matching. Matching module 232 may include its own fuzzy logic algorithms therein. Each of fuzzy logic module 230 and matching module 232 may be configured as a dedicated controller or other integrated circuit, or implemented as code/software on systems 108 and/or 202, to be executed by one or more processors of systems 108 and/or 202.

FIG. 2E illustrates an example process flow 250 for a transaction processed in connection with N&V computing system 108 in accordance with one example embodiment of the present disclosure. At step 252, merchant 110 generates an authorization request (e.g., request 220) with an indicator that merchant 110 would like for certain information of a user 102 to be validated. At step 254, the request (e.g., request 220) is sent as a message (e.g., message 222) from processor network 104 to issuer 114 for approval. At step 256, issuer 114 checks the information of user 102 for accuracy against its records and responds with a message (e.g., message 224) including an appropriate reason code. At step 258, network operator 106 logs (e.g., via communication 226) information of user 102 in an authoritative database (e.g., 216) associated with N&V computing device 108 if the response from issuer 114 indicates that the information of user 102 is accurate. At step 260, a response (e.g., response 228) is returned to merchant 110 in order to complete the payment as normal. The information of user 102 may include name information, address information, postal code information, and/or any other information commonly utilized in system 100 for payments. Each of the messages (e.g., requests/responses/communications) described in connection with process flow 250 of FIG. 2D may be an ISO 8583 message as described herein.

FIGS. 3A, 3B, 3C, and 3D illustrate aspects of logging verified information of user 102 and how such information is normalized in accordance with N&V computing system 108. FIG. 3A illustrates a plurality of normalization steps for the normalization of (e.g., unnormalized) data via N&V computing system 108. Such unnormalized data may (i) already be present in records of network operator 106 and/or issuer 114 or another entity (e.g., merchant 110) within payment system 100 (e.g., acquired from the conduction and/or verification of prior transactions), (ii) be data that network operator 106 may acquire (e.g., scrape, purchase) from third parties (e.g., public records, data vendors), and/or (iii) data that is obtained from other parties (e.g., issuer 114) of system(s) 100/200. Table 300 in FIG. 3A illustrates (i) a series of normalization steps that are performed on data that has not yet been normalized (unnormalized data), (ii) a solution as to how such data is normalized for each step, and (iii) examples of such normalization, where applicable. These normalization steps may be performed sequentially (e.g., a series of sequential steps) or in another preferred order. Each normalization step includes its own rules for how to handle the occurrence of certain text, characters, symbols, punctuation, and other graphical objects (e.g., emojis) and the like for data included, for example, within data elements of a computer message such as an ISO 8583 message as described herein. As shown in FIG. 3A, field 302 of table 300 is a normalization step field, listing, for example, thirteen different normalization steps. Field 304 lists the particular manner in which each step in field 302 solves the problem of normalizing unnormalized data. Unnormalized data may be viewed as unnormalized characters. Field 306 provides examples of normalized information. The examples in field 306 show before and after comparisons of certain strings before and after normalization. The headings and format of table 300 are for example purposes only and other headings and formats may be utilized.

As shown in FIG. 3A, a normalization step 308 (e.g., normalization step 1) includes fixing Latin1 UTF-8 encoding, where the rules of normalization step 1 record any characters from ISO 8859-1 (Latin 1) in the range 0x80 . . . 0xFF as 2 bytes in UTF-8.

As shown in FIG. 3A, a normalization step 310 (e.g., normalization step 2) includes stripping escape characters, where the rules of normalization step 2 include removing/reducing Unicode and Html escape characters. A first example of the normalization performed by normalization step 2 includes the string “a\\\\tb” being normalized to “a\tb”, where 4 repeated backward slashes (“\\\\”) are reduced to one backward slash (“\”) according to the rules of normalization step 2. A second example of the normalization performed by normalization step 2 includes the string “&lt;a&gt;” being normalized to “<a>”, where escape characters such as (i) “&lt” (e.g., less than), (ii) “; ”, and (iii) “&gt” (e.g., greater than) are removed/replaced according to the rules of normalization step 2.

As shown in FIG. 3A, a normalization step 312 (e.g., normalization step 3) includes substituting separators with a space, where the rules of normalization step 3 replace any + or _ character(s) with a space. A first example of the normalization performed by normalization step 3 includes the string “a+b” being normalized to “a b”, where the + character is replaced by a space according to the rules of normalization step 3. A second example of the normalization performed by normalization step 3 includes the string “a_b” being normalized to “a b”, where the _ character is replaced with a space according to the rules of normalization step 3.

As shown in FIG. 3A, a normalization step 314 (e.g., normalization step 4) includes normalizing punctuation characters and apostrophes. The rules of normalization step 4 include: (i) any kind of hyphen or dash is/are replaced with a dash of the type “-”, (ii) apostrophes from any character set are replaced with the apostrophe from the Latin character set, and (iii) apostrophes, where they are not followed by a word, are removed. An example of the normalization performed by normalization step 4 includes the string “′'mcdonalds'′'s′'” being normalized to “mcdonald's”, where characters such as “‘” and “’” are removed according to the rules of normalization step 4.

As shown in FIG. 3A, a normalization step 316 (e.g., normalization step 5) includes reducing (e.g., multiple) white space and dashes, where the rules of normalization step 5 include reducing (e.g., multiple) white space and dashes down to one space or one dash, respectively. A first example of the normalization performed by normalization step 5 includes the string “a----b” being normalized to “a-b”, where the multiple dashes (“----”) are reduced to one dash (“-”) according to the rules of normalization step 5. A second example of the normalization performed by normalization step 5 includes the string “a b” being normalized to “a b”, where the multiple spaces (e.g., “ ”) are reduced to one space (“”) according to the rules of normalization step 5.

As shown in FIG. 3A, a normalization step 318 (e.g., normalization step 6) includes separating numeric characters, where the rules of normalization step 6 include separating numeric characters from non-numeric characters with spaces. An example of the normalization performed by normalization step 6 includes the string “a1b” being normalized to “a 1 b”, where a space is added between letters and numbers according to the rules of normalization step 6.

As shown in FIG. 3A, a normalization step 320 (e.g., normalization step 7) includes decoding Unicode characters, where the rules of normalization step 7 include converting certain characters (e.g., Unicode characters) to other (e.g., ASCII7-only) characters using a library (e.g., JUnidecode library). For example, normalization step 7 assists with name matching aspects (e.g., matching algorithms) of the normalization techniques described herein, as certain (e.g., Latin) characters are preferred for name matching. Normalization step 7 is therefore helpful in connection with translations. A first example of the normalization performed by normalization step 7 includes the string “résumé” (e.g., French text) being normalized to “resume” according to the rules of normalization step 7. A second example of the normalization performed step 7 includes the string “ [symbol] ” (e.g., Greek text) being normalized to “Ellenika” according to the rules of normalization step 7. A third example of the normalization performed step 7 includes the string “ [symbol] ” (e.g., Chinese text) being normalized to “Mao” according to the rules of normalization step 7. A fourth example of the normalization performed step 7 includes the string “ [symbol] ” (e.g., non-translatable object (e.g., emoji)) being normalized to “” according to the rules of normalization step 7. Transliteration normalization may also be included in normalization step 7.

As shown in FIG. 3A, a normalization step 322 (e.g., normalization step 8) includes normalizing symbols to a space or removing the symbols. The rules of normalization step 8 include replacing characters from certain categories (e.g., the “Symbol,” “Punctuation,” and “Other” Unicode categories) with a space (except for dash and ampersand) or removing characters from the “Symbol,” “Punctuation,” and “Other” Unicode categories (except for dash and ampersand). An example of the normalization performed by normalization step 8 includes the string “a-b'c$‡ [symbol] [symbol] {[]}d” being normalized to “a-b'c e”, where symbols such as “$”, “‡”, “ [symbol] ”, “ [symbol] ”, “{”, “[”, and “}” are removed according to the rules of normalization step 8.

As shown in FIG. 3A, a normalization step 324 (e.g., normalization step 9) includes removing unknown characters. The rules of normalization step 9 include removing unknown characters “[?]” that may result from if a library such as JUnidecode cannot decode a certain (e.g., Unicode) character. An example of the normalization performed by normalization step 9 includes the string “a [?]b” being normalized to “a b”, where the unknown character [?] is removed according to the rules of normalization step 9.

As shown in FIG. 3A, a normalization step 326 (e.g., normalization step 10) includes stripping whitespaces. The rules of normalization step 10 include replacing any kind of whitespace or other invisible separator with a single space (e.g., for multiple types of whitespaces). An example of the normalization performed by normalization step 10 includes the string “a -b” being normalized to “a b”, where the whitespace is replaced with a single space according to the rules of normalization step 10.

As shown in FIG. 3A, a normalization step 328 (e.g., normalization step 11) includes splitting text such as names that are written in camel-case. The rules of normalization step 11 include inserting spaces between name parts if they are written in camel-case. An example of the normalization performed by normalization step 11 includes the string “JohnJDoe” being normalized to “John J Doe,” where spaces are inserted between the names/initials written in camel-case according to the rules of normalization step 11.

As shown in FIG. 3A, a normalization step 330 (e.g., normalization step 12) includes converting certain upper case letters to lowercase letters. The rules of normalization step 12 include converting an input string to lowercase. An example of the normalization performed by normalization step 12 includes the string “AbCd” being normalized to “abcd” according to the rules of normalization step 12.

As shown in FIG. 3A, a normalization step 332 (e.g., normalization step 13) includes removing unnormalized characters, where the rules of normalization step 13 include removing all characters not normalized (e.g., only leaving spaces, numbers, letters, and ampersand characters). An example of the normalization performed by normalization step 13 includes the string “malcolm d\u0000o#$n′a~l [symbol] d's ” being normalized to “malcolm donald's” according to the rules of normalization step 13.

Normalization steps 308, 310, 312, 314, 316, 318, 320, 322, 324, 326, 328, 330, and 332 may be referred to as “normalization steps 1-13” or just “normalization steps.” Normalization steps 1-13 are merely examples, and other normalization steps and corresponding rules are envisioned. By virtue of these normalization steps, the strings of the normalized (and authenticated) data can be used to populate an authenticated database containing verified information of user(s) 102, and the normalized (and authenticated) information is usable in connection with populating ISO 8583 messages described herein, for example. The generated normalized information, which is highly standardized, verified, and transportable, is usable within payment system(s) 100/200 as authenticated data, for use in authenticating future transactions and/or as part of (e.g., issuer) stand-in the manners described herein. This represents a significant improvement in information processing technology in the payment processing technology field as it streamlines and optimizes data transmission.

Moreover, the normalized information, in particular normalized names, are usable for providing various match signals (such as email-to-name, address-to-name, etc.) that are generated and provided during the transaction process. To generate match signals, it is typically necessary to gather names from customer queries and an authoritative datastore (such as provider data). Due to the beneficial normalizing described herein, the normalized information such as normalized names that is stored in an authoritative database (e.g., database 216) has names that are in the correct format and that are consistent, which improves the ability to perform name matching and generate match signals. For example, by virtue of the normalized names having the same acceptable format, matching can more easily be performed via a matching algorithm. Any algorithms (e.g., matching algorithm and/or fuzzy logic algorithm) described herein may be programmed and/or trained (in the case of an artificial intelligence (AI) trained algorithm, such as a machine-learning (ML) trained algorithm) to determine preform their intended function, such as determining relationships between information sets (e.g., determine a match, help determine a match, or make other related determinations). This may be done independent of or in partial reliance on parameters similar to those described in connection with respect to the string analysis/parsing features of the various normalization steps 1-13 as shown in FIG. 3A. For example, a matching algorithm according to one embodiment of the present disclosure may rely on various string markers, and may include character string matching and/or pattern matching algorithms (such as brute force, linear-time exact, regular expression algorithms or the like) and/or combinations of the foregoing, which may be employed to detect matching information.

These name matching aspects are not limited to names of individuals, but can be applied to business names as well, including affiliates and DBA entities. User(s) 102 may include a business instead of an individual. Normalization steps 1-13 are performed on business names acquired from multiple sources (e.g., names provided by data partners and/or names received in customer queries). The normalized business names therefore have the same acceptable format to perform matching via a matching algorithm as described herein. Additionally, the various DBA's and other subsidiary entities of a single larger corporation may be linked together in a common user profile so that verification for any one of the associated entities is streamlined along the lines described herein with respect to names of individuals, thereby improving the processing of payment transactions involving businesses. The matching algorithm may also be applied to address information.

FIG. 3B illustrates a table 350 in accordance with one example embodiment of the present disclosure. Table 350 may be referred to as normalized and validated user data table 350, and includes entries that result from the logging process performed via N&V computing system 108 described in connection with FIGS. 2C and 2D and as shown in FIGS. 2C and 2D, as well as the normalization steps, techniques, and processes described herein, such as in FIG. 3A. Table 350 includes a name field 352 for names, an address field 354 for addresses, a postal code field 356 for postal codes, a valid field 358 for indicating if the information is valid (or has been validated), and a last validated time field 360 for indicating the last date/time information was validated. For example, field 358 may be reflective of the validity indicator provided along with the information included in response message 224. The information present in fields 352, 354, and 356 represents, without limitation, information that can be normalized via the normalization steps in FIG. 3A and the normalization techniques described herein. With reference to response 224 in FIG. 2C and step 258 in FIG. 2D, valid field 358 will be populated with a “YES” (e.g., “Y”) entry if the information from issuer 114 is valid (and similarly a “NO” (e.g., “N” entry) if not). The date and/or time that this information was validated is stored in last validated time field 360. Field 362 (e.g., row 362) represents name (e.g., field 352), address (e.g., field 354), postal code (e.g., field 356), and validity information (e.g., fields 358 and 360) of a user 102 (e.g., a first user 102). Field 364 (e.g., row 364) represents name (e.g., field 352), address (e.g., field 354), postal code (e.g., field 356), and validity information (e.g., fields 358 and 360) of another user 102. Field 366 (e.g., row 366) represents name (e.g., field 352), address (e.g., field 354), postal code (e.g., field 356), and validity information (e.g., fields 358 and 360) of an n^{th} user 102. The headings and format of table 350 are for example purposes only and other headings and formats may be utilized. N&V computing device 108 may be configured to seek re-validation of information after a certain period of time has passed, or periodically, or due to the occurrence of a certain event. For example, re-validation of the information may be required every month, or if any next transaction is determined to have been too far removed from the prior transaction, such that the information may no longer be accurate. For example, if a year has passed since a user 102 last used a particular credit card for a purchase, the validation process may be configured to request re-validation. The user information present in table 350 may be referred to as user profile information, and each field 362, 364, 366 may be referred to as a user profile. A user profile including normalized data may be referred to as a normalized user profile.

FIG. 3C illustrates an example process flow 368 for normalization via N&V computing system 108 in accordance with one example embodiment of the present disclosure. At step 370, unnormalized information of a user 102 is sourced (e.g., name, address, and/or postal code information as described herein). This unnormalized information may be sourced from internal information present in the records of network operator 106, such as from prior transactions involving user 102 that were processed by network operator 106, or sourced by other means described herein. At step 372, information of user 102 is analyzed in accordance with parameters of the normalization steps and techniques described herein, such as normalization steps 308 . . . 332 (e.g., normalization steps). At step 374, the information of user 102 is normalized according to the rules of normalization steps 1-13. Step 374 may also include correcting information that, using fuzzy logic, has been determined to be incorrect. For example, as described herein, if address information has already been verified and stored in the authoritative database, and non-matching information is received via a request (e.g., from merchant 110, such as via message 220), fuzzy logic may be utilized to correct the inaccurate address when responding to merchant 110. This may include using fuzzy logic to fill in the blanks or deductively determine the address provide by merchant 110 has to be a certain address. For example, if address “123 Grey Oaks Street” does not exist, the fuzzy logic determines, based on other accurate information such as the name and postal code, that the address more likely than not was intended to be “123 Grayoaks Street,” and correction can be made according to the determination of the fuzzy logic. At step 376, the normalized information is stored in a normalized data database, e.g., an authoritative database including verified, normalized/corrected data (this authoritative database may be realized via database 216 or another database that is part of N&V computing system 108, network operator system 202, or a database that is otherwise part of system(s) 100/200). At step 378, the stored, normalized, and verified data is referenced in connection with a transaction process as shown in FIG. 2C (or FIG. 2D) to carry out user authentication, stand-in, and/or other aspects as described herein. As information of user(s) 102 may become stale and/or inaccurate over time, process flow 368 also includes step 380 for updating information of user(s) 102. This may involve performing separate and/or new validations to ensure, for example, that an address of a user is still accurate. In operation, if a user 102 suddenly starts using a new address, or otherwise submits paperwork with an entity such as a post office that they have moved residences, this sort of event may be relied upon as a trigger that information for that particular user needs to be updated. As described herein, N&V computing device 108 may be configured to seek re-validation of information after a certain period of time has passed.

FIG. 3D illustrates an example computer message that has been modified by N&V computing system 108 according to FIG. 2C or 2D. Computer message 382 shown in FIG. 3D may be an ISO 8583 message, and includes an MTI 384, a bitmap 386, a first data element 388 for names (e.g., name data element 388), and a second data element 390 for addresses (e.g., address data element 390). Computer message 382 may be referred to herein as an enhanced response message. A name 392 of “JohnJDoe” (in camel-case) was transmitted via an original message (e.g., message 220 from merchant 110) and has been normalized to name 394 “John J Doe” according to normalization step 328 in FIG. 3A. The normalized name 394 has been linked/appended (e.g., in a new field) to data element 388 and sent to merchant 110 (e.g., via message 228). An address 396 of “123 Grey Oaks St 12345” was also transmitted via the original message (e.g., message 220 from merchant 110) and has been corrected to address 398 to confirmed proper address of “123 Grayoaks St 12345” according to the verified information in the authoritative database (e.g., using techniques such as the above-described fuzzy logic) and sent to merchant 110 (e.g., via message 228). Corrected address 398 has been linked/appended (e.g., in a new field) to data element 390. For example, the authorized database may have been populated when message 224 (e.g., from issuer system 208) confirmed the name as being “John J Doe” and the address as being “123 Grayoaks St 12345.” N&V computing system 108 may be configured to control corrections based on verified data as well as conduct normalization of data. For example, N&V computing system 108 can update the authoritative database upon receipt of message 224 (e.g., from issuer 114) confirming the accuracy of the name and address information, so that the confirmed accurate information is stored in the authoritative database. While FIG. 3D illustrates an example of normalized and verified data between linked or otherwise appended to the original (e.g., unnormalized and unverified) data as part of enhanced response message 382, in some embodiments enhanced response message 382 may instead provide only the normalized and verified data. In any case, the requesting party may use either version of enhanced response message 382 to update the data in their own records, so that the data of the requesting party is updated over time to be more and more accurate, reaping the benefits described herein. For example, once the requesting party receives enhanced response message 382, a computing device of the requesting party may trigger storage of the normalized and verified data in a database associated with the requesting party. Any next request message or similar message sent by the requesting party may then utilize the latest updated data (e.g., instead of outdated data).

As an example of how process flow 368 may be performed as part of the operation of N&V computing system 108, take the example scenario of a fictional user 102 named John J Doe. With respect to normalization step 328 as shown in FIG. 3A, field 362 as shown in FIG. 3B, and data element 388 in FIG. 3D, unnormalized name information “JohnJDoe” may be present in a name authorization request (e.g. message 220) from merchant 110. If issuer 114 replies to message 222 via message 224 that the name “John J Doe” is accurate, the normalized name (e.g., name 394 shown in FIG. 3D) is stored via communication 226 in the authoritative database and is linked/appended to a corresponding data element (e.g., DE 388) of a computer message (e.g., message 382, which may be an ISO 8583 message and realized as message 228) sent to merchant 110. As part of this process, N&V computing system 108 parses unnormalized name 392 and determines that the text “JohnJDoe” is written in camel-case and needs to be normalized. According to the rules of normalization step 328, a space should be inserted between parts of the name, meaning that “JohnJDoe” should be normalized to “John J Doe.” After “JohnJDoe” is normalized to “John J Doe,” this normalized name 394 is then stored (e.g., step 376 in FIG. 3D) in the authoritative database for subsequent usage as part of transactions that occur within payment system(s) 100/200. Address 396 in FIG. 3D is analyzed for accuracy, and may be corrected by fuzzy logic (e.g., via fuzzy logic module 230). For example, as described herein, fuzzy logic module 230 determines that address 396 is inaccurate and corrects the address to address 398. This may be separate from or in conjunction with any matching algorithm applied to determine if an address match exists.

Further, as an example of how this normalized data is used in a new transaction (e.g., step 378 of FIG. 3C), when a new transaction according to FIG. 2C (or FIG. 2D) takes place, communication 226 may indicate whether or not the information of user 102 matches the verified information stored in the authoritative database (e.g., database 216) according to the matching algorithm described herein. Additionally, while process flow 368 is described in connection with network operator 106, process flow 368 can be performed by another entity such as a third party that has been permitted by network operator 106 to carry out normalization, or another entity within payment system(s) 100/200 that has been assigned such a role.

In some embodiments, a data element such as data element 388, 390 may indicate approval or decline of the transaction which may be embedded in the enhanced response message, and the stand-in rules stored within the database may include a rule that authorizes a processing party such as network operator 106 to stand-in for issuer 114 and/or issuer processor 120 to authorize the transaction on behalf of the issuer/issuer processor by either approving or declining the transaction.

In some embodiments, the user data is stored in a database associated with a requesting party such as a merchant, and a computing device such as network operator system 202 causes a computing device within merchant system 204 or merchant bank system 206 to update the user data of the account holder with the normalized and verified user data included in the normalized and verified data element.

In some embodiments, a requesting party computing device may generate updated user data of the account holder by one of: (i) replacing the user data with the normalized and verified user data; or (ii) linking/appending the user data with the normalized and verified user data such as shown in FIG. 3D. This process provides the requesting party with a periodic refresh of the latest normalized and verified user data, improving the overall accuracy and validity of data within the processing network, and streamlining future transactions while further reducing the amount of messages exchanged between parties in the processing network, representing a significant technical improvement in the payment processing technology sector. The updated user data may be included by the requesting party in place of the user data present in a first/original request message for any subsequent request message sent by the requesting party after the sending of the first/original request message.

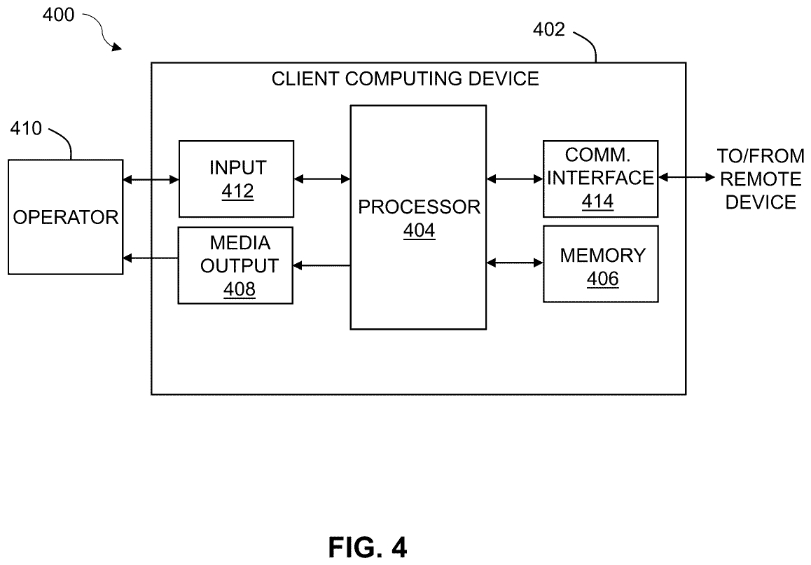

FIG. 4 illustrates an example configuration of a client sub-system 400 of system(s) 100/200, including a client computing device 402. Client computing device 402 may include, but is not limited to, merchant system 204, merchant bank system 206, issuer system 208, and third party system 218 (shown in FIGS. 2A and 2B), according to one embodiment of the present disclosure. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media storing instructions executable by processor 404.

Client computing device 402 also includes at least one media output component 408 for presenting information to an operator 410 (e.g., operator of client systems 204, 206, 208, 218). Media output component 408 is any component capable of conveying information to operator 410. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 412 for receiving input from operator 410. Input device 412 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 412.

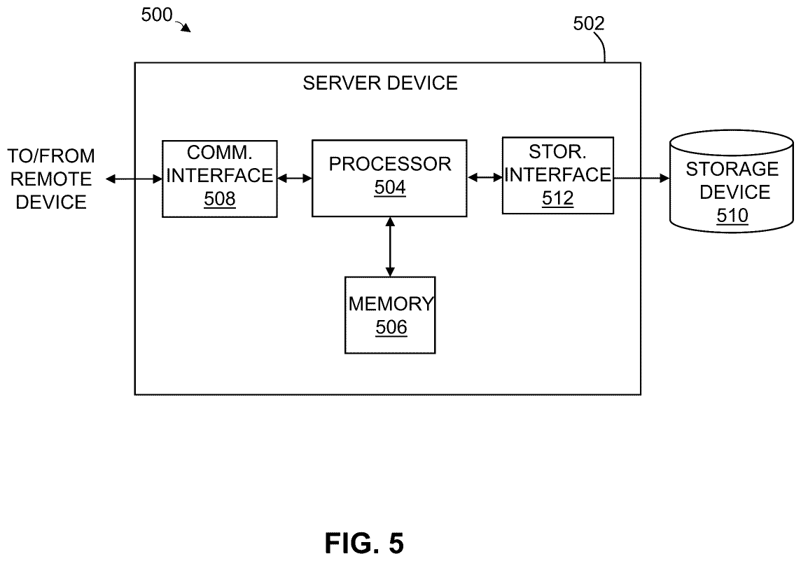

Client computing device 402 may also include a communication interface 414, which is communicatively countable to a remote device such as a server system (e.g., server system 502 shown in FIG. 5) or a web server. Communication interface 414 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 406 are, for example, computer-readable instructions for providing a user interface to operator 410 via media output component 408 and, optionally, receiving and processing input from input device 412. A user interface may include, among other possibilities, a web browser and client application. Web browsers enable operator(s) 410 to display and interact with media and other information typically embedded on a web page or a website from a web server. A client application allows operator(s) 410 to interact with a server application associated with, for example, N&V computing system 108. The user interface, via one or both of a web browser and a client application, facilitates displaying prompts generated by N&V computing system 108. The user may interact with the user interface to view and respond to prompts using input device 412. While FIG. 4 describes aspects of client computing device 402, corollary elements to elements 404, 406, 408, 410, 412, and 414 may also be present for network operator system 202. Moreover, the remote device referenced in FIG. 4 may include any device (e.g., 108, 118, 202, 204, 206, 208, 212, 214, 216, 218, shown in FIGS. 2A and 2B) that is part of system(s) 100/200, with transmission via to/from such remote device(s) being via network 210, for example.

FIG. 5 illustrates an example configuration of a server (e.g., a host computing device) sub-system 500 such as processing network server 212, and/or database server 214 (shown in FIGS. 2A and 2B) used to receive transaction data associated with payment transactions and authenticate users of the payment transactions using a normalization service.

Server device 502 includes a processor 504 for executing instructions. Such instructions may be stored in a memory area 506, for example. Processor 504 may include one or more processing units (e.g., in a multi-core configuration) for executing instructions. The instructions may be executed within a variety of different operating systems on the server device 502, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 504 is operatively coupled to a communication interface 508 such that server device 502 is capable of communicating with a remote device such as another server device 502 (or another device of system(s) 100/200). For example, communication interface 508 may receive requests from processing network server 212 and/or database server 214 via the Internet, as illustrated in FIGS. 2A and 2B. Processor 504 may also be operatively coupled to a storage device 510 (e.g., memory area 510). Storage device 510 is any computer-operated hardware suitable for storing and/or retrieving data. In some embodiments, storage device 510 is integrated in server device 502. For example, server device 502 may include one or more hard disk drives as storage device 510. In other embodiments, storage device 510 is external to server device 502 and may be accessed by a plurality of server devices 502. For example, storage device 510 may include multiple storage units such as hard disks or solid state disks in a redundant array of inexpensive disks (RAID) configuration. Storage device 510 may include a storage area network (SAN) and/or a network attached storage (NAS) system. In some embodiments, server device 502 also includes a database server, such as database server 214 (shown in FIGS. 2A and 2B).

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory area 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

In a similar manner as discussed above in connection with servers 212 and 214, database 216 also includes a processor (similar to processor 504), a memory (similar to memory 506), and storage (similar to storage device 510), and may also include a communication interface (similar to communication interface 508) and a storage interface (similar to storage interface 512).

The term “processor,” as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program. Any memory described herein may be non-transitory.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor and can be implemented in a high-level procedural and/or object-oriented programming language, and/or in assembly/machine language, and can be implemented as any algorithms described herein. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of normalizing and validating data present in payment transactions provides a cost-effective and reliable means for having and utilizing reliable, normalized, and verified purchaser data within a payment processing network. As a result, the methods and systems described herein facilitate leveraging a processing network's assets to provide added value to issuers and merchants in an enhanced payment transaction message in a cost-effective and reliable manner.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for generating normalized and validated user data from unnormalized data, the computer system comprising a normalization and validation computing device comprising at least one processor and a memory device in communication with the at least one processor, the at least one processor configured to:
receive a request message including (i) an indicator requesting validation of user data of a cardholder initiating a transaction, and (ii) the user data in a plurality of data elements of the request message;
receive a response message in response to the request message, wherein the response message includes a validity indicator associated with the plurality of data elements, the validity indicator configured to indicate whether one or more data elements of the plurality of data elements is valid;
store the one or more valid data elements as validated user data in a validated user database;
analyze the validated user data to determine unnormalized characters present within at least one character string of the validated user data;
normalize the unnormalized characters by performing at least one of a plurality of normalization steps on the at least one character string to generate normalized characters;
generate normalized user data based on the normalized characters; and
transmit to a sender of the request message an enhanced response message that includes the normalized user data located adjacent to the user data that was received via the request message, thereby providing the normalized user data to the sender.

2. The computer system of claim 1, wherein each normalization step of the plurality of normalization steps includes a set of rules for detecting and modifying occurrences of the unnormalized characters within the at least one character string.

3. The computer system of claim 1, wherein the plurality of normalization steps includes at least one of: modifying encoding/decoding of characters; modifying escape characters; substituting characters; modifying punctuation; reducing an amount of characters; separating characters; deleting characters; and modifying a letter case of characters.

4. The computer system of claim 1, wherein:
the plurality of data elements includes at least one of (i) a name data element, and (ii) an address data element, the name data element including user name data, and the address data element including user address data;
the validity indicator is associated with the at least one of (i) the name data element, and (ii) the address data element, wherein the validity indicator indicates whether the user name data and/or the user address data is valid;
the one or more valid data elements include the validated user name data and the validated user address data; and
the normalized user data includes normalized user name data and normalized user address data.

5. The computer system of claim 4, wherein the user address data includes an address number, an address name, and a postal code associated with the address number and the address name.

6. The computer system of claim 4, wherein the at least one processor is further configured to:
build a normalized user data table that includes a plurality of normalized user profiles, each normalized user profile including corresponding normalized user name data and corresponding normalized user address data;
store the normalized user data table in a normalized user data database associated with the normalization and validation computing device; and
analyze the request message to determine if a match exists between the user data and the normalized user data by performing a lookup within the normalized user data database and comparing the user data to the normalized user data.

7. The computer system of claim 6, wherein the normalized user data table includes last validated time information representing the last time validation was performed.

8. The computer system of claim 1, wherein the request message comprises an ISO 8583 message or an ISO 20022 message, and the plurality of data elements comprises data elements of the ISO 8583 message or the ISO 20022 message.

9. The computer system of claim 1, wherein the at least one processor is further configured to apply fuzzy logic to a subset of data within the user data of the request message to assist with determining a match between the user data and the normalized user data.

10. The computer system of claim 1, wherein the at least one processor is configured to analyze the request message to determine if a match exists between the user data and the normalized user data, and transmit to the sender of the request message (i) a replicated response message if a match is determined to exist, or (ii) the enhanced response message if no match is determined to exist.

11. A computer-implemented method for generating normalized and validated user data from unnormalized data, the method implemented by a computer system including one or more processors in communication with one or more memories, the method comprising:
receiving a request message including (i) an indicator requesting validation of user data of a cardholder initiating a transaction, and (ii) the user data in a plurality of data elements of the request message;
receiving a response message in response to the request message, wherein the response message includes a validity indicator associated with the plurality of data elements, the validity indicator configured to indicate whether one or more data elements of the plurality of data elements is valid;
storing the one or more valid data elements as validated user data in a validated user database;
analyzing the validated user data to determine unnormalized characters present within at least one character string of the validated user data;
normalizing the unnormalized characters by performing at least one of a plurality of normalization steps on the at least one character string to generate normalized characters;
generating normalized user data based on the normalized characters; and
transmitting to a sender of the request message an enhanced response message that includes the normalized user data located adjacent to the user data that was received via the request message, thereby providing the normalized user data to the sender.

12. The method of claim 11, wherein the plurality of normalization steps includes at least one of: modifying encoding/decoding of characters; modifying escape characters; substituting characters; modifying punctuation; reducing an amount of characters; separating characters; deleting characters; and modifying a letter case of characters.

13. The method of claim 11, wherein the request message comprises an ISO 8583 message or an ISO 20022 message, and the plurality of data elements comprises data elements of the ISO 8583 message or the ISO 20022 message.

14. The method of claim 11, further comprising applying fuzzy logic to a subset of data within the user data of the request message to assist with determining a match between the user data and the normalized user data.

15. The method of claim 11, further comprising analyzing the request message to determine if a match exists between the user data and the normalized user data, and transmitting to the sender of the request message (i) a replicated response message if a match is determined to exist, or (ii) the enhanced response message if no match is determined to exist.

16. One or more non-transitory computer-readable storage media with instructions stored thereon that, in response to being executed, cause a computer system for generating normalized and validated user data from unnormalized data to:
receive a request message including (i) an indicator requesting validation of user data of a cardholder initiating a transaction, and (ii) the user data in a plurality of data elements of the request message;
receive a response message in response to the request message, wherein the response message includes a validity indicator associated with the plurality of data elements, the validity indicator configured to indicate whether one or more data elements of the plurality of data elements is valid;
store the one or more valid data elements as validated user data in a validated user database;
analyze the validated user data to determine unnormalized characters present within at least one character string of the validated user data;
normalize the unnormalized characters by performing at least one of a plurality of normalization steps on the at least one character string to generate normalized characters;
generate normalized user data based on the normalized characters; and
transmit to a sender of the request message an enhanced response message that includes the normalized user data located adjacent to the user data that was received via the request message, thereby providing the normalized user data to the sender.

17. The one or more non-transitory computer-readable storage media of claim 16, wherein the plurality of normalization steps includes at least one of: modifying encoding/decoding of characters; modifying escape characters; substituting characters; modifying punctuation; reducing an amount of characters; separating characters; deleting characters; and modifying a letter case of characters.

18. The one or more non-transitory computer-readable storage media of claim 16, wherein the request message comprises an ISO 8583 message or an ISO 20022 message, and the plurality of data elements comprises data elements of the ISO 8583 message or the ISO 20022 message.

19. The one or more non-transitory computer-readable storage media of claim 16, wherein the instructions, when executed, further cause the computer system to apply fuzzy logic to a subset of data within the user data of the request message to assist with determining a match between the user data and the normalized user data.

20. The one or more non-transitory computer-readable storage media of claim 16, wherein the instructions, when executed, further cause the computer system to analyze the request message to determine if a match exists between the user data and the normalized user data, and transmit to the sender of the request message (i) a replicated response message if a match is determined to exist, or (ii) the enhanced response message if no match is determined to exist.
